(19) United States
(12) Patent Application Publication
(10) Pub. No.: US 2026/0230878 A1
(43) Pub. Date: Aug. 6, 2026

(54) METHODS, APPARATUSES AND SYSTEMS FOR ON-DEMAND TRP WAKE-UP FOR MULTI-TRP TRANSMISSIONS

(71) Applicant: InterDigital Patent Holdings, Inc., Wilmington, DE (US)

(72) Inventors: Umer Salim, Vallauris (FR); Loic Canonne-Velasquez, Dorval (CA); Paul Marinier, Brossard (CA); Janet Stern-Berkowitz, Little Neck, NY (US); Tao Deng, New York, NY (US); Jaya Rao, Montreal (CA); Faris Alfarhan, Montreal (CA)

(21) Appl. No.: 19/044,172

(22) Filed: Feb. 3, 2025

(51) Int. Cl. H04W 24/10; H04W 52/02

(52) U.S. Cl. CPC H04W 24/10; H04W 52/0206

(57) ABSTRACT

Procedures, methods, apparatuses, systems, devices, and computer program products for on-demand transmit/receive point, TRP, wake-up for multi-TRP transmissions. A wireless transmit/receive unit, WTRU, measures reference signals, RSs, received from, TRPs, in a first set of TRPs to obtain first measurements, measures RSs received from TRPs in a second set of TRPs to obtain second measurements, evaluates a wake-up condition based upon a measured RS in a subset of the first measurements and a measured RS in the second measurements, and, on condition that the wake-up condition is satisfied, transmits to the network a wake-up signal, the wake-up signal requesting the TRP having transmitted the strongest measured RS in the second measurements to wake up.

### TECHNICAL FIELD

The present disclosure is generally directed to the fields of communications, software and encoding, including, for example, to methods, apparatuses, systems directed to on-demand transmit/receive point, TRP, wake-up for multi-TRP transmissions.

### SUMMARY

In a first aspect, the present principles are directed to a method at a wireless transmit/receive unit, WTRU, the method including measuring reference signals, RSs, received from transmit/receive points, TRPs, in a first set of TRPs to obtain first measurements, measuring RSs received from TRPs in a second set of TRPs to obtain second measurements, evaluating a wake-up condition based upon a measured RS in a subset of the first measurements and a measured RS in the second measurements, and on condition that the wake-up condition is satisfied, transmitting a wake-up signal, the wake-up signal requesting the TRP having transmitted the strongest measured RS to wake up.

In embodiments, the wake-up condition is evaluated based upon the measurement corresponding to a weakest measured RS in the subset of the first measurements and the measurement corresponding to a strongest measured RS in the second measurements. The wake-up condition can be evaluated based on a difference between the measurement corresponding to the strongest measured RS in the second measurements and the measurement corresponding to the weakest measured RS in the subset of the first measurements. The wake-up condition can be satisfied in case the difference is greater than a given value.

In embodiments, a configured periodicity of RS transmission of the first set of TRPs is higher than a configured periodicity of RS transmission of the second set of TRPs.

In embodiments, the method includes verifying that the TRP having transmitted the strongest measured RS has woken up.

In embodiments, the method includes measuring reference signals, RSs, received from transmit/receive points, TRPs, including the TRP having transmitted the strongest measured RS to obtain third measurements, and reporting channel state information based on the third measurements.

In embodiments, the method includes determining, based on the first measurements and using at least one evaluation criterion, a set of pre-coding matrices for coherent joint transmission to achieve a Quality of Service, QoS, and selecting a pre-coding matrix from the set of pre-coding matrices, wherein the selected pre-coding matrix is for a subset of the first set of TRPs, and wherein the subset of the first measurements correspond to measurements from the subset of the first set of TRPs.

In a second aspect, the present principles are directed to a wireless transmit/receive unit, WTRU, including at least one processor configured to measure reference signals, RSs, received from transmit/receive points, TRPs, in a first set of TRPs to obtain first measurements, measure RSs received from TRPs in a second set of TRPs to obtain second measurements, evaluate a wake-up condition based upon a measured RS in a subset of the first measurements and a measured RS in the second measurements, and on condition that the wake-up condition is satisfied, transmit a wake-up signal, the wake-up signal requesting the TRP having transmitted the strongest measured RS to wake up.

In embodiments, the at least one processor is configured to evaluate the wake-up condition based upon the measurement corresponding to a weakest measured RS in the subset of the first measurements and the measurement corresponding to a strongest measured RS in the second measurements. The at least one processor can be configured to evaluate the wake-up condition based on a difference between the measurement corresponding to the strongest measured RS in the second measurements and the measurement corresponding to the weakest measured RS in the subset of the first measurements. The wake-up condition can be satisfied in case the difference is greater than a given value.

In embodiments, a configured periodicity of RS transmission of the first set of TRPs is higher than a configured periodicity of RS transmission of the second set of TRPs.

In embodiments, the at least one processor is configured to verify that the TRP having transmitted the strongest measured RS has woken up.

In embodiments, the at least one processor is configured to measure reference signals, RSs, received from transmit/receive points, TRPs, including the TRP having transmitted the strongest measured RS to obtain third measurements, and report channel state information based on the third measurements.

In embodiments, the at least one processor is configured to determine, based on the first measurements and using at least one evaluation criterion, a set of pre-coding matrices for coherent joint transmission to achieve a Quality of Service, QoS, and selecting a pre-coding matrix from the set of pre-coding matrices, wherein the selected pre-coding matrix is for a subset of the first set of TRPs, and wherein the subset of the first measurements correspond to measurements from the subset of the first set of TRPs.

In a third aspect, the present principles are directed to a method at a wireless transmit/receive unit, WTRU, the method including measuring, in a network, reference signals, RSs, received from transmit/receive points, TRPs, in a first set of TRPs to obtain first measurements, determining, based on the first measurements and using at least one evaluation criterion, one or more pre-coding matrices for coherent joint transmission to achieve a Quality of Service, QOS, validating the determined one or more pre-coding matrices with respect to the QoS targets, in case no pre-coding matrix is validated, measuring RSs received from TRPs in a second set of TRPs to obtain second measurements, determining, using the second measurements and at least one determination criterion, TRPs of the second set of TRPs, and providing to the network an indication of the determined TRPs.

In embodiments, the determined TRPs correspond to highest measured signal strengths among the second measurements.

In a fourth aspect, the present principles are directed to a wireless transmit/receive unit, WTRU, including at least one processor configured to measure, in a network, reference signals, RSs, received from transmit/receive points, TRPs, in a first set of TRPs to obtain first measurements, determine, based on the first measurements and using at least one evaluation criterion, one or more pre-coding matrices for coherent joint transmission to achieve a Quality of Service, QoS, validate the determined one or more pre-coding matrices with respect to the QoS targets, in case no pre-coding matrix is validated, measure RSs received from TRPs in a second set of TRPs to obtain second measurements, determine, using the second measurements and at least one determination criterion, TRPs of the second set of TRPs, and provide to the network an indication of the determined TRPs.

In embodiments, the determined TRPs correspond to highest measured signal strengths among the second measurements.

In a fifth aspect, the present principles are directed to a method at a wireless transmit/receive unit, WTRU, the method including measuring, in a network, reference signals, RSs, received from transmit/receive points, TRPs, in a first set of TRPs to obtain first measurements, determining, based on the first measurements, a plurality of pre-coding matrices for coherent joint transmission to achieve a Quality of Service, QoS, validating, using at least one evaluation criterion, whether at least one of the determined plurality of pre-coding matrices respect the QoS targets, and in case no pre-coding matrix is validated, providing to the network an indication of wake-up of a second set of TRPs.

In a sixth aspect, the present principles are directed to a wireless transmit/receive unit, WTRU, including at least one processor configured to measure, in a network, reference signals, RSs, received from transmit/receive points, TRPs, in a first set of TRPs to obtain first measurements, determine, based on the first measurements, a plurality of pre-coding matrices for coherent joint transmission to achieve a Quality of Service, QoS, validate, using at least one evaluation criterion, whether at least one of the determined plurality of pre-coding matrices respect the QoS targets, and in case no pre-coding matrix is validated, provide to the network an indication of wake-up of a second set of TRPs.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example of joint transmission from multiple TRPs to a UE.;

FIG. 3 illustrates a first method according to an embodiment of the present principles;

FIG. 4 illustrates a second method according to an embodiment of the present principles; and FIG. 5 illustrates a third method according to an embodiment of the present principles.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

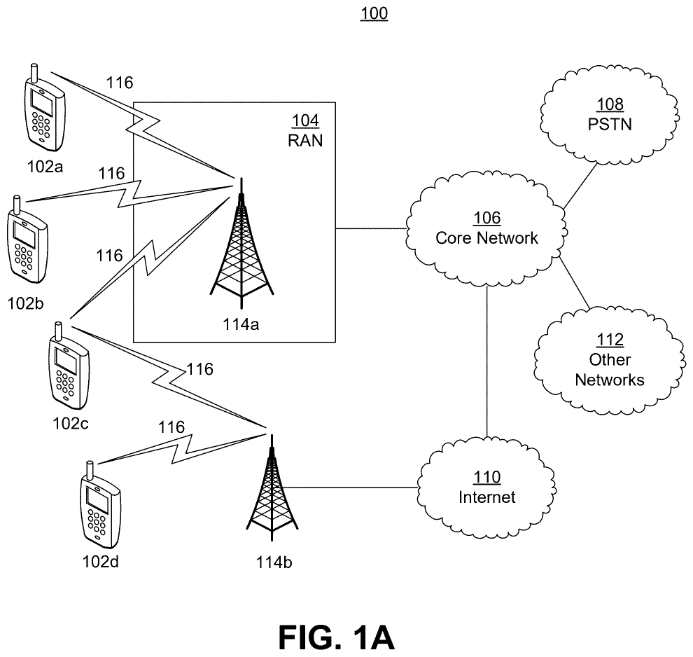

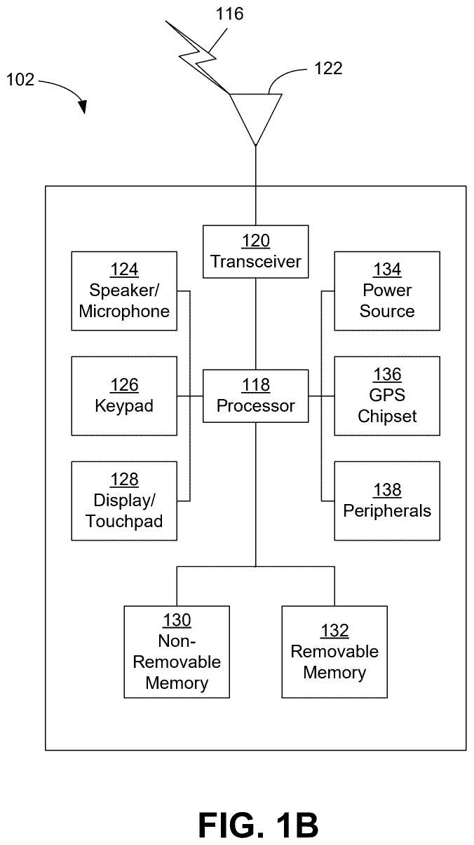

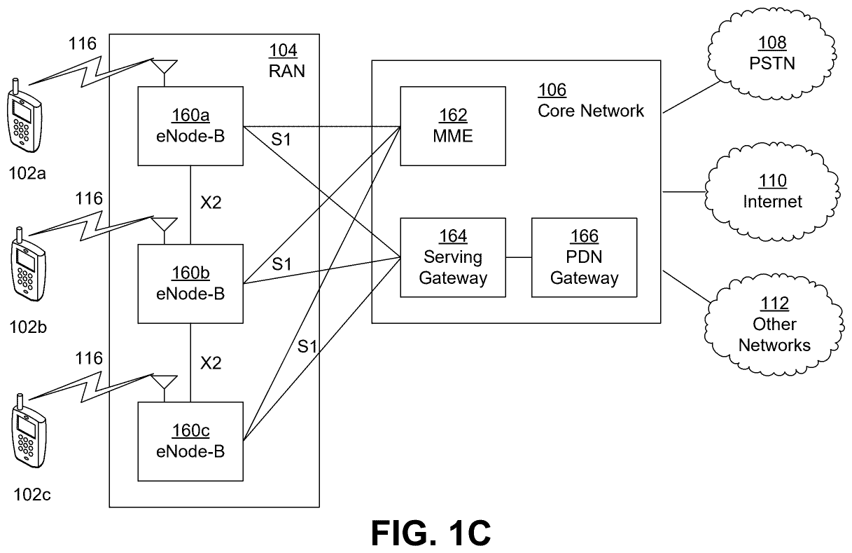

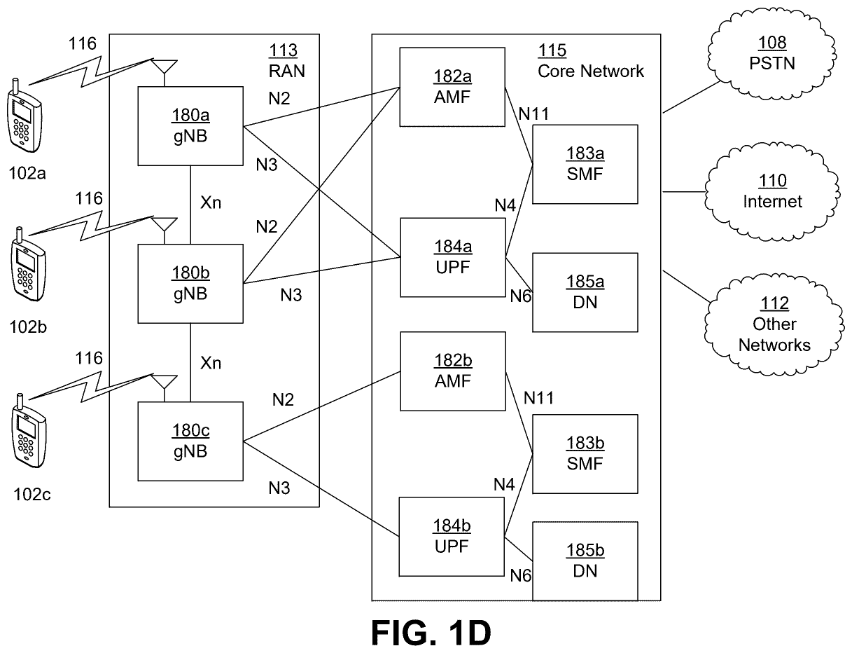

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire (i.e. obtain) location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In Rel- 17, 5G NR introduced enhancements to the Channel State Information (CSI) reporting framework to support more efficient reporting for scenarios with multiple Transmit Receive Points (TRPs) in Non-Coherent Joint Transmission (NCJT). CSI resource and reporting settings were addressed without changes to any codebooks.

In Coherent Joint Transmission (CJT), more than one TRP transmits simultaneously to a UE. Data is available and sent from multiple TRPs at the same time, and the precoder ensures that the signal is received coherently at the UE. The precoder is applied across multiple antennas located at the multiple TRPs. This involves applying suitable amplitude weights, phases and relative phase shifts to antennas at the multiple TRPs to enable coherent signal reception/combining at a UE.

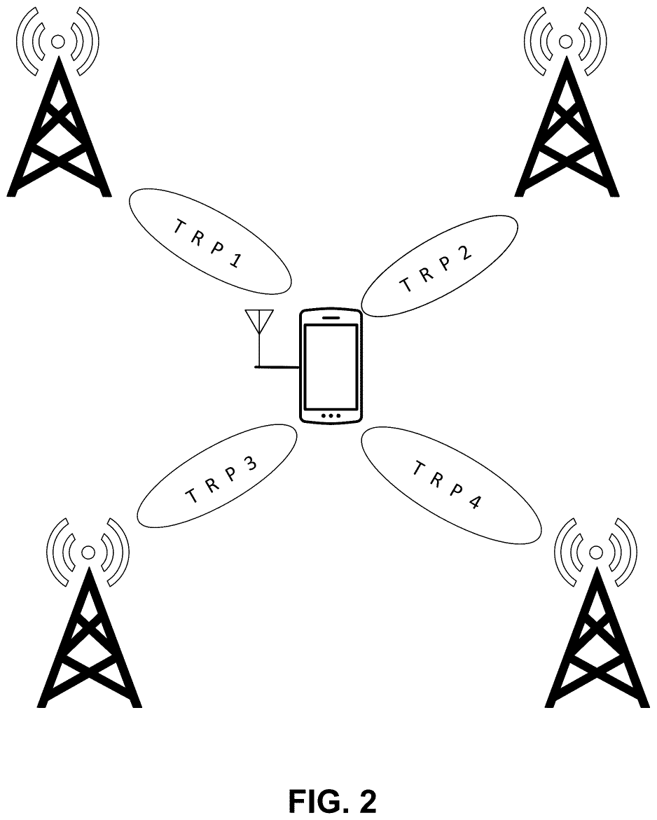

FIG. 2 illustrates an example of joint transmission from multiple (in the example 4) TRPs to a UE.

Rel-18 MIMO specifies improved CSI acquisition for Frequency Division Duplex (FDD) CJT based upon Type II CSI reporting framework. Rel-18 specifies CSI acquisition for CJT targeting FR1 and up to 4 TRPs, assuming ideal backhaul, synchronized TRPs, and the same number of antenna ports across TRPs.

Rel-19 MIMO is discussing CJT enhancements under non-ideal synchronization and non-ideal backhaul between multiple TRPs with UE measurements and reporting of inter-TRP misalignment and frequency/phase offset.

In other words, 3GPP has been specifying series of enhancements to multi-TRP based NCJT and CJT under different aspects targeting (i) accurate CSI feedback, (ii) CSI feedback compression, (iii) CSI for non-ideal backhaul, etc.

In parallel, much effort is going into network energy savings with specification support for (i) cell DTx/DRx, (ii) power/spatial domain adaptations for single TRP, (iii) on-demand Synchronization Signal Block (SSB), (iv) on-demand SIB1, etc., but so far, the network energy savings have not been discussed in the context of multi-TRP transmissions (or CJT).

An example setting of the present principles is in very dense TRP deployment scenarios, targeting 6G deployments in urban areas.

Given the effort to save energy, it is assumed that the network tries to keep the TRPs (or micro TRPs) in longer sleep cycles to maximize the energy savings, and these TRPs may only be transmitting large periodicity Reference Signal (RS) (e.g., SSBs and/or CSI-RS).

It is further assumed that to harness the CJT benefits without sacrificing the deep sleep energy benefits of micro TRPs, the network may target fast activation of sleeping micro TRPs to join the CJT transmission set for UEs.

Rel-18 specified CSI enhancements for CJT from up to 4 TRPs. In the current framework, and the UE provides feedback to maximize its throughput without considering energy consumption.

Rel-19 NES is discussing on-demand SSB for Scell activation for connected mode UEs and on-demand SIB1 for idle mode UEs.

As will be appreciated, so far, energy saving mechanisms have not been discussed in CJT feedback and CJT transmissions.

Before going into details, an embodiment of the present principles will be presented. According to the embodiment, for coherent joint transmissions in heterogeneous TRP deployments including first (e.g. macro) TRPs (always on TRPs for coverage) and second (e.g. micro/femto) TRPs (opportunistically on TRPs for capacity), a UE measures the CSI-RS from a set of the first TRPs. For CSI feedback targeting CJT, if a UE-measured power difference between a first TRP in CJT transmission set and a second TRP exceeds a given value (e.g. threshold), the UE transmits an UL Wake-Up Signal (WUS) to wake-up (one or more) suitable second TRPs.

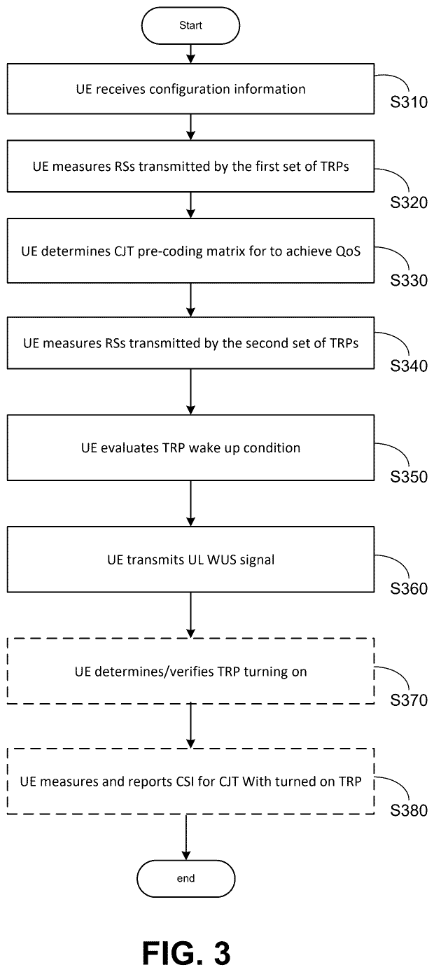

FIG. 3 illustrates a first method according to an embodiment of the present principles. Briefly speaking, in at least an embodiment the first method is for UE on-demand TRP wake-up for MTRP transmissions.

In step S310, a UE receives information indicative of a network configuration for coherent joint transmission from a first set of TRPs (e.g., macro TRPs) and a second set of TRPs (e.g., micro TRPs). The UE can use the information to configure itself. The information includes of one or more of one or more RSs (e.g., CSI-RSs) for CSI measurements and feedback (possibly respectively) associated with the TRPs of the first set with a first periodicity, one or more RSs (e.g., SSB, slim SSB, low periodicity SSB/CSI-RS) for measurements and feedback (possibly respectively) associated with the TRPs of the second set with a second periodicity, UL-WUS configuration information associated with TRPs of the second set of (micro) TRPs (e.g., Random Access Channel (RACH) config), TRP wake-up condition and threshold (e.g., estimated power/RSRP difference between the measurements of the weakest measured (macro) TRP in the determined CJT pre-coding matrix over the first set minus the largest measured RSRP of a TRP in the second (micro) TRP set larger than a threshold), target rank (e.g., the overall rank of the reported pre-coding matrix equal to or exceeding a threshold L), and reliability restriction (e.g., the CQI associated with the reported pre-coding matrix equal to or exceeding a threshold C). The first periodicity is typically higher than the second periodicity, i.e. it occurs more often.

In step S320, the UE measures received RSs transmitted by the first set of (macro) TRPs, as per the received configuration information.

In step S330, the UE determines a pre-coding matrix for at least one subset of the first set of TRPs for coherent joint transmission to achieve a QoS (rank/reliability etc.), based upon the measurements over the first set of (e.g., macro) TRPs, and selects a determined pre-coding matrix (e.g. the best according to an evaluation criterion).

In step S340, the UE measures received RSs transmitted by the second set of (e.g., micro) TRPs, as per the received configuration. It is noted that these measurements typically take place on a different time scale than that of the measurements in step S320 (e.g., the normal CSI reporting period).

In step S350, the UE evaluates the wake-up condition based upon the weakest measured RS of the TRP in the subset corresponding to the selected determined pre-coding matrix and the strongest measured RS of the second set, e.g. by calculating the difference and comparing this with a given value (e.g. a threshold).

On condition that the condition is satisfied, in step S360, the UE transmits, to the network, a UL WUS signal that causes the TRP in the second set with the strongest measured RS to wake up. Having woken up, the TRP transmits with the first frequency, i.e. at a higher than frequency than when using the second frequency.

In step S370, the UE can verify (i.e. determine) that the TRP has turned on.

In step S380, the UE can measure and report CSI for CJT incorporating the woken-up TRP.

It will be appreciated that the present principles can enable the network to energy by putting the (opportunistically ON) TRPs in the second set to a lower energy state or completely turning them off to return to a higher energy state or turning back on for transmissions at the second periodicity (i.e. interval) while TRPs in the first set are used for coherent transmissions at the first periodicity (i.e. more often than at the second frequency). In case a UE measures a (possibly significant) received power difference of TRPs in first set versus the TRPs in the second set, the UE can request targeted wake-up of sleeping TRPs by transmitting an UL WUS signal to the target TRPs.

### Network Energy Savings (NES) Terminology

Some terminology used herein will now be discussed.

Channel conditions: any conditions relating to the state of the radio/channel, which may be determined by the UE from: a UE measurement (e.g., L1/Signal-to-Interference-and-Noise Ratio (SINR)/Reference Signal Received Power (RSRP), Channel-Quality Indicator (CQI)/Modulation and Coding Scheme (MCS), channel occupancy, Received Signal Strength Indicator (RSSI), power headroom, exposure headroom), L3/mobility-based measurements (e.g. RSRP, Reference Signal Received Quality (RSRQ), s-measure), a Radio Link Monitoring (RLM) state, and/or channel availability in unlicensed spectrum (e.g. whether the channel is occupied based on determination of a Listen-Before-Talk (LBT) procedure or whether the channel is deemed to have experienced a consistent LBT failure).

Physical Random-Access Channel (PRACH) resource: a PRACH frequency resource (e.g., in frequency), a PRACH occasion (RO) (e.g., in time), a preamble format (e.g., in terms of total preamble duration, sequence length, guard time duration and/or in terms of length of cyclic prefix) and/or a preamble sequence used for the transmission of a preamble in a random-access procedure.

A property of scheduling information (e.g., an uplink grant or a downlink assignment) may include of at least one of: a frequency allocation, an aspect of time allocation (such as time instance and/or a time duration), a priority, a modulation and coding scheme, a transport block size, a number of spatial layers, a number of transport blocks to be carried, a transmission Configuration Indicator (TCI) state or SRS Resource Indicator (SRI), a number of repetitions, whether the grant is a configured grant type 1 (i.e., UE immediately using the configured UL resources after receiving the configuration information), type 2 (i.e., UE waiting until an explicit MAC CE indication before using the configured UL resources) or a dynamic grant.

An indication (by Downlink Control Information (DCI)) may include at least one of an explicit indication by a DCI field or by Radio-Network Temporary Identifier (RNTI) used to mask Cyclic Redundancy Check (CRC) of the Physical Downlink Control Channel (PDCCH), an implicit indication by a property such as DCI format, DCI size, Coreset or search space, aggregation level, identity of first control channel resource (e.g., index of first Control Channel Element (CCE)) for a DCI, where the mapping between the property and the value may be signaled by Radio Resource Control (RRC) or MAC, and an explicit indication by a DL MAC CE.

“A” and “an” can be interpreted as “one or more” or “at least one”. Similarly, any term which ends with the suffix “(s)” is to be interpreted as “one or more” or “at least one”. The term “may” can be interpreted as “may, for example”. The symbol “/” (e.g., forward slash) can represent “and/or,” where for example, “A/B” may imply “A and/or B”.

Network Availability States/Cell DTx mode/TRP DTx Mode/NES states

A NES state or an availability state may refer to a cell state or a TRP state in which the cell or TRP has activated at least one NES technique, including: reduced SSB transmission (periodic or existence), reduced RS transmission (e.g., CSI-RS, periodic or semi-persistent), reduced SIB1 transmission (periodic or existence), cell DTx, cell DRx, TRP DTx, TRP DRx, spatial domain adaptation (where a subset of antenna ports and/or elements are turned off), power domain adaptation (where a subset of channels are transmitted with reduced power or muted), and/or the cell or TRP has turned off.

The UE may determine whether it can transmit or receive on certain resources depending on a network availability state, which implies the power savings status for the cell or TRP or gNB. An availability state may correspond to a network energy savings state, a cell DTx mode, a cell DRx mode, a TRP DTx mode, a TRP DRx mode, and/or a gNB activity level. An availability state can be uplink or downlink specific, and may change from symbol to symbol, slot to slot, frame to frame, or on longer duration granularity. The availability state may be determined by the UE or indicated by the network. An availability state can be, for example, “On”, “DL and UL active”, “UL only active”, “off”, “reduced Tx power”, “dormant”, “sleep (de-)activated”, “micro sleep”, “light sleep”, “deep sleep”, the active period of a sleep pattern, and/or the inactive period of a sleep pattern. In a sleep pattern, the active period may correspond to the time when the network (NW) may actively transmit DL signals/channels and/or the time when the NW may blind decode for UL signals/channels. Such states can be abstracted by NW configuration parameters and/or values, and dynamic indication may point to the active availability state (e.g. by DCI or MAC CE signaling). The “Off” availability state, the inactive state or the non-active period of sleep pattern may imply that the cell/TRP/gNB's baseband hardware is completely turned off. The “sleep” availability state may imply that the cell/TRP/gNB wakes up periodically to transmit certain signals (e.g. presence signals, synchronization, or reference signals) or receive certain UL signals. In some availability states, some DL or UL resources are not available during certain periods of time, which enables the network to turn off baseband processing and other activities. For example, the UE may be configured by RRC with periodic Active and Inactive periods per availability. Some measurement resources (e.g. SSBs or CSI-RS) may only be made available in certain availability states, including: RLM, beam failure discovery (BFD), Radio Resource Management (RRM) measurements, CSI-RS feedback configuration, and/or a different power offset for CSI feedback.

Under certain conditions, a UE may transmit a request to the network (wake-up request) to modify the availability state to a state in which resources that would satisfy UE requirements are available. The UE may determine an availability state from reception of availability state indication from e.g. by L1/L2 signaling (e.g. a group common DCI or indication), or implicitly determine it from the reception of periodic DL signaling or based upon lack of a signal or signaling.

The UE determines if a resource is available for transmission/reception and/or measurements for the determined network availability state if it is applicable in the active availability state. In addition, the UE may also adapt its active C-DRx cycle, active spatial elements (e.g. antenna or logical ports), active TRPs, paging occasions as a function of the signaled or determined availability state. The UE may be configured with one or more sets of NES transmission and/or reception parameters per availability state, e.g. by broadcast or dedicated configuration signaling. The UE may apply the NES parameter set according to the determined or signaled availability state. The UE may apply one or more applicable configurations depending on the determined NES state. A NES parameter set may include: a number of antenna ports, a C-DRx configuration, a measurement configuration (e.g. for RRM, RLM, and/or BFD), CSI feedback, a CSI-RS configuration (e.g., different parameters for different NES states), an SSB configuration, conditional handover (CHO) or mobility candidates, a set of active TRPs.

An availability state may be applicable to at least one transmission, reception, or measurement resource. An availability state may be applicable to at least one time period such as a time slot or time symbol. An availability state may be applicable to a serving cell, a cell group, a frequency band, a bandwidth part, a TRP, a TRP of a specific type (e.g., micro TRP, macro TRP, a coverage TRP, a capacity TRP etc.), a set of spatial elements, or a range of frequencies within a bandwidth part. For example, when an NES state changes in a cell, the UE may receive an availability state change indication indicating that this change is just for that cell, for all cells at the same frequency, or/and same RAT.

The UE may consider the active availability state associated with a cell, carrier, TRP, or frequency band to be “Off”, “Deep sleep”, or “Micro sleep” after reception of a DL signaling that changes the cell's or TRP's availability state. For example, the UE may receive a turn off command on broadcast signaling, RRC signaling, DCI (e.g. a group common DCI), or a DL MAC CE (e.g. indication part of PDSCH). The UE may determine an availability state from reception of availability state indication from e.g. by L1/L2 signaling (e.g. a group common DCI or indication) or broadcast signaling associated with an availability state. For example, an availability state change indication could also be part of SI update or SIB signaling (e.g. in a separate SIB that is not read by legacy UEs) and there can be a common time for all UEs in the cell to determine availability state status; the UE may determine a change of NES state from the reception of a group common command L1 signaling (e.g., a group common DCI, a multi-stage DCI, a specific DCI format, or a DCI scrambled by a configured or specified NES-specific RNTI) that may indicate one of the configured NES parameters sets to apply or may determine a delta configuration from the current set of parameters upon determining an NES state change and the UE may transmit feedback/acknowledgment to the gNB, possibly multiplexed with UL data (e.g., part of an UL TB as a MAC CE or a subheader indication), following the reception of NES state change indication; the UE may determine a change of NES state from the reception of broadcast signaling associated with NES state indication or change, including signaling in SIB(s) or part of a broadcast or multicast PDSCH, be indicated the NES state explicitly in the SIB, be configured with one or more SIBs exclusively associated with configuration of NES parameters, be configured to receive such broadcast or multicast indication periodically, determine an indication is mis-detected if not received on expected periodic occasions, if a number of misdetections is counted, and/or if a timer has elapsed since the last reception of the NES state indication, may start inter-cell, inter-frequency, and/or inter-RAT measurements, start a mobility procedure, and/or start evaluating configured CHO candidates following the determination of a misdetection of the NES state indication; the UE may determine a change of NES state by detecting a change in one of the physical parameter values in the reference signals transmitted by a TRP, a cell or a gNB (as an example, the UE detecting a change of periodicity of RS (e.g., SSB or CSI-RS) transmitted by a TRP/cell may be an indication for the UE that the TRP/cell has changed the NES state, or the cell/TRP has changed its sleep pattern, or the cell/TRP has woken up, etc.)

The UE may implicitly assume a certain availability state associated with a cell, carrier, TRP, or frequency band (e.g., “Off, ”deep sleep“, ”micro sleep“ or dormant”) from at least one of the following: detecting one of the physical properties in the received RS (e.g., SSB, CSI-RS) from a TRP/Cell, e.g., UE detecting SSB/CSI-RS with a reduced periodicity compared to a normal/nominal periodicity, UE detecting SSB/CSI-RS transmitted from a low power Tx of TRP/cell instead of being transmitted by the normal/high-power Tx of the TRP/Cell; reception of a command or signal indicating a change in availability state, e.g., a group common DCI in connected mode or RRC signaling or a presence signal, may determine an availability state implicitly form the reception of periodic DL signaling, and may be configured or specified to associate an availability state with one or more DL signal type (e.g., SSB, partial SSB, and/or one or more periodicity; reception of a paging message, paging DCI, paging PDSCH, or a paging related signal (e.g., PEI), possibly on a subset of POs (e.g., those aligned with NES DRx cycle or a configured subset of PDCCH resources), the UE may assume a certain availability state after reception of an indication part of the DCI or PDCCH scheduling paging (e.g., as a function of the P-RNTI, NES-RNTI or based on receiving an explicit indication-e.g., on a reserved bit), the UE may assume a certain availability state after the reception of a paging message with a certain P-RNTI, a separately configured NES P-RNTI, or the NES group RNTI, the UE may assume a certain availability state after the reception of a paging message with a certain P-RNTI, the UE may be configured with one more PEI subgroup for NES, where a subgroup may be associated with one or more availability state, the UE may assume a certain availability state after reception of a PEI with an NES subgroup, possibly if that subgroup is configured and/or associated with the availability state, the indication of the availability state or the availability state switch may be indicated in the paging payload, e.g., as a flag part of the paging message or the short message, such a paging indication may further indicate an alternative cell to monitor paging on while the cell from which the signaling was received is off, sleep, or in NES state, such a paging indication may further indicate or signal applicable reconfiguration parameters (e.g., for initial access, applicable PRACH resources, applicable SSB/RS occasions, applicable SI cycle, and/or the applicable cell(s) and associated availability states); the gNB DTx status (whether the gNB is in active time or an associated activity timer is running); lack of detection of a presence indication, the UE may determine an availability state associated with the cell (e.g., “off” or “deep sleep”) if presence indication was not detected on one or more presence indication occasion, the UE may assume or change the cell's availability state after a number of consecutive misdetections or after timer expires following no detection of a presence signal, the UE may determine an availability state is active or de-active after expiry of a timer associated with the availability state, such a timer can be configured and/or maintained in connected mode only, or also in other states (e.g., idle and inactive states), the UE may determine an availability state implicitly form the lack of reception of periodic DL signaling, for example, the UE may be configured with a signal quality threshold (e.g., an RSRP threshold) and if the UE does not detect a signal associated with an availability state (e.g., a presence signal or an SSB) with a signal strength above the threshold, the UE may assume that this availability state is not active and may assume a different availability state, this criterion can be also coupled with lack of detection of an identifying sequence of the presence signal (e.g., detection of the PSS sequence for example); based on time in the day, the UE may be configured to automatically assume a certain availability state (e.g. off, sleep, or dormant) for a configured subset of cells (e.g. capacity boosting cells) depending on the time in the day, for example, the UE may determine that a capacity boosting cell has an availability state as “On” in certain hours of the day, “Deep sleep” in other configured hours, and “Off” in a third set of configured hours of the day or night; based on the availability state of an associated cell (e.g. another carrier of the same MAC entity, another carrier in the same cell group, another carrier in the same gNB, another sector in the same gNB, or a configured associated cell or capacity boosting cell); detection of a PSS only signal or a simplified/stripped down SSB signal; detection of an RS signal (e.g. CSI-RS, PRS, TRS) or the lack thereof; the UE's RRC state (Idle, inactive, or connected mode); whether paging has been received, possibly within a configured time window; whether system information (e.g. periodic SI or a subset of SIBs) have been received, possibly within a configured time window; measured channel condition(s) being below—or above—a threshold, the UE may assume a change of NES state based on a change of measured channel conditions or making a channel measurement below—or above—a threshold, for example, the UE may use degradation in measurements of SSBs or CSI-RS, possibly in combination with other signaling-to determine the NES state, for example, a configured window following the DCI reception can be used to measure SSBs and/or CSI-RS for degradation, and if a delta of SSB-RSRP drop is measured the UE may determine that the NES state has changed and assume associated actions for such NES state (e.g. trigger for CHO candidate selection or for group scheduling for a mobility command).

The UE may be configured to monitor an indication characterizing the level of network activity (e.g. an availability state). The network activity may be associated with a TRP and/or gNB and/or a cell. The UE may assume the same availability state for all cells part of the same TRP/gNB, e.g. cells of the same MAC entity. The network activity indication (e.g. the presence indication) may consist of a channel (e.g., a PDCCH) and/or a signal (e.g., a sequence). The activity indication or the NES state change indication/command may indicate the level of activity the UE may expect from the associated TRP/gNB and/or cell, e.g., reduced activity. The activity indication may include activity information of other gNBs/cells. The activity indication may be a PDCCH including group common signaling. For example, the NW may transmit a group common DCI to a group of UEs (e.g. UEs in the serving cell) indicating a change of an activity state or activity level in UL and/or DL. The CRC of the PDCCH may be scrambled with a dedicated “activity indication RNTI or an NES-RNTI”. The UE may be configured with at least one search space associated with the monitoring occasions of the activity indication PDCCH. The indication may include a go-to-sleep signal (e.g., a predefined sequence). When the UE detects this sequence, it may expect a reduced activity level over a specific time duration. The UE may activate C-DRX for the period of time indicated. Alternatively, two sequences may be used to indicate regular activity and reduced activity. The signaling within the PDCCH or the activity indication may include at least one of the following: expected activity level of the associated gNBs/cells over a specific time interval (e.g. an availability state), the activity levels may be predetermined and/or configured and may include regular and reduced activity, the signaling may indicate the activity level, for example, a bit “1” may indicate regular activity and “0” may indicate reduced activity; for each activity level (e.g. availability state), transmission and reception attributes may be defined, for example, during reduced activity, the UE may not be expected to monitor certain PDCCH search spaces (including all SSs), and/or receive a certain type of PDSCH (including all PDSCH), and/or transmit PUCCH/PUSCH, and/or perform certain measurements, the UE may start or stop monitoring PDCCH and/or TCI states associated with determined NES state, including PDCCH resources or TCI states associated with (de)activated TRPs or spatial elements; a set of configurations may be associated with an activity level and may be used/applied when that activity level is indicated (e.g. an NES parameter set), for example, SS configurations, CSI reporting configurations, indices of transmitted SSBs, etc., each set of configurations may have an attribute associated with an activity level, for example, a tag that can be set to “reduced activity”; the time interval over which an activity level is assumed may be signaled in the PDCCH or part of the activity indication (the time interval may be indicated using a bitmap where each bit in the bitmap may be associated with a specific duration, e.g., a slot or a frame, for example, a bit set to “1” may indicate regular activity while the bit set to “0” may indicate reduced activity on an associated frame; the time interval may be indicated with a start time and length of interval, the start time may be defined, for example, it may be determined by adding a fixed offset to the time the indication is received, the length of the interval may be configured or signaled in the indication PDCCH); the time interval over which an activity level is assumed may be predetermined, the UE may assume an interruption delay (or more generally a time till the NES state changes) after the NES state change command reception (e.g. after the last symbol or slot on which the command was received), the interruption time can be in absolute time, a number of symbols, or a number of slots.

The UE may determine that an uplink or downlink resource or signal is available for transmission/reception and/or measurements for the determined network availability state if it is applicable in the active availability state. The UE may determine that a subset of measurement resources and/or signals (e.g. SSBs, CSI-RS, TRS, PRS) are not applicable in certain availability states. The UE may determine that a subset of uplink or downlink resources (e.g. PRACH, PUSCH, PUCCH) are not applicable in certain availability states. The UE may transmit uplink signals only in a subset of NW availability states (e.g. SRS, pSRS, PRACH, UCI).

The present description and claims use the terms “network NES state”, “TRP NES state” and “cell NES state” interchangeably. A UE may know the NES state for one or more TRPs, one or more cells, e.g., through network configuration and indication. When used as network NES state, it means the NES states of one or more TRPs/cells which could be serving TRPs/cells, neighbor TRPs/cells etc. A NES state may imply an activation state only for a NES state, while another NES state may correspond to the deactivation state. The terms network availability state, TRP state, cell turned off, SIB1-less operation, reduced SIB 1/SSB periodicity state, (in-)active cell DTx mode/configuration, or NES state may be used interchangeably. The UE may determine an SSB/SIB1 transmission state (periodicity and/or whether they are transmitted) implicitly from a determined active availability state, and vice-versa. Herein, a NES TRP/cell may refer to a TRP/cell that is applying at least one NES technique, is in a NES state (e.g. activated NES state), and/or is capable or configured to apply an NES technique at some point. Therefore, a non-NES TRP/cell may be used to refer to any TRP/cell that is not designated as a NES TRP/cell per this definition (e.g. not in a NES state or cannot/does not apply a NES technique). In one alternative, the designation of which TRP/cell that can be NES TRP/cell may be configured (e.g. by broadcast or dedicated signaling).

In one or more NES state(s), a UE may transmit a wake-up signal (e.g. PRACH, SR, PUCCH, UCI on PUCCH, a MAC CE or UE assistance information) to request a change in the NES state, additional UL or DL resources, reception of on demand SSB, reception of SSB/CSI-RS with normal periodicity, reception of on demand SIB1/SI, or activation of a TRP, wake-up of a TRP, activation of a given cell (e.g. on that is in a NES state). Examples of triggers for the UE to transmit a wake-up signal and/or request reception of normal RS (e.g., SSB and/or CSI-RS etc.) include: detection of a reference signal, detecting a physical property of the RS with a certain behavior (e.g., reduced periodicity), making a channel measurement on the TRP/cell or an associated TRP/cell less than or greater than a threshold, arrival of new data (possibly for a given LCH/LCG), amount of buffered data exceeding a threshold (possibly for a given LCH/LCG), based on positioning being within a given range, based on triggering BSR/SR, based on triggering a L3 mobility events, based on the UE or TRP/cell DTx/DRx status, based on expiry of a timer, and/or the UE receiving a request from higher layers to transmit on-demand SSB request.

### MIMO Terminology

Beam A UE may transmit or receive a physical channel or reference signal according to at least one spatial domain filter. The term “beam” may be used to refer to a spatial domain filter.

The UE may transmit a physical channel or signal using the same spatial domain filter as the spatial domain filter used for receiving a reference signal (RS) (such as CSI-RS) or a synchronization signal (SS) block (SSB). The UE transmission may be referred to as “target”, and the received RS or SS block may be referred to as “reference” or “source”. In such a case, the UE may be said to transmit the target physical channel or signal according to a spatial relation with a reference to such RS or SS block.

The UE may transmit a first physical channel or signal according to the same spatial domain filter as the spatial domain filter used for transmitting a second physical channel or signal. The first and second transmissions may be referred to as “target” and “reference” (or “source”), respectively. In such case, the UE may be said to transmit the first (target) physical channel or signal according to a spatial relation with a reference to the second (reference) physical channel or signal.

A spatial relation may be implicit, configured by radio resource control (RRC) layer or signaled by media access control (MAC) layer control element (CE) or downlink (DL) control information (DCI). For example, a UE may implicitly transmit a physical uplink shared channel (PUSCH) and demodulation reference signal (DMRS) of PUSCH according to the same spatial domain filter as a sounding reference signal (SRS) indicated by an SRS resource indicator (SRI) indicated in DCI or configured by RRC. In another example, a spatial relation may be configured by RRC for an SRI or signaled by MAC CE for a physical uplink control channel (PUCCH). Such a spatial relation may also be referred to as a “beam indication”.

The UE may receive a first (target) downlink channel or signal according to the same spatial domain filter or spatial reception parameter as a second (reference) downlink channel or signal. For example, such association may exist between a physical channel such as physical downlink control channel (PDCCH) or physical downlink shared channel (PDSCH) and its respective DMRS. At least when the first and second signals are reference signals, such association may exist when the UE is configured with a quasi-colocation (QCL) assumption type D between corresponding antenna ports. Such association may be configured as a transmission configuration indicator (TCI) state. A UE may be indicated an association between a CSI-RS or SSB and a DMRS by an index to a set of TCI states configured by RRC and/or signaled by MAC CE. Such an indication may also be referred to as a “beam indication”.

Herein, the expression “RS” may be interchangeably used with one or more of “RS resource”, “RS resource set”, “RS port” and “RS port group”. “RS” may also be interchangeably used with one or more of “SSB”, “CSI-RS”, “SRS” and “DMRS”.

### TRP, MTRP, M-TRP

Herein, the expression “TRP” may be interchangeably used with one or more of “TP” (transmission point), “RP” (reception point), “RRH” (radio remote head), “DA” (distributed antenna), “BS” (base station), a “sector” (of a BS), and a “cell” (e.g., a geographical cell area served by a BS). Herein, the expression “Multi-TRP” may be interchangeably used with one or more of “MTRP”, “M-TRP”, and “multiple TRPs”.

A UE may be configured with different types of TRPs. The UE may be configured with macro TRPs and/or micro TRPs. More generally, the UE may be configured with Type 1 TRPs and Type 2 TRPs.

Type 1 TRPs may correspond to any of macro TRPs, or more capable TRPs (e.g., more hardware/antenna/power), or coverage providing TRPs, or fully awake TRPs. Type 1 TRPs may also correspond to HIGHER network preference/priority for being used in multi-TRP transmissions. Type 1 TRPs may correspond to any one or more of Macro TRPs, TRPs equipped with a number of Tx and/or Rx and/or RF chains larger than a threshold value, TRPs equipped with power amplifiers with certain characteristics (e.g., max power being larger than a threshold value), TRPs having max transmission power larger than a threshold value, a set of TRPs that are fully awake (e.g., transmitting RS/SSB/CSI-RS with normal periodicity), a set of TRPs following a specific NES state (e.g., high energy active state), a set of always ON TRPs, and a set of TRPs providing coverage (e.g., which may be transmitting syncs signals periodically and may be used for initial access etc.).

Type 2 TRPs may correspond to any of micro TRPs, or less capable TRPs (e.g., less hardware/antenna/power), or capacity providing TRPs, or opportunistically awake TRPs. Type 2 TRPs may also correspond to LOWER network preference/priority for being used in multi-TRP transmissions. Type 2 TRPs correspond to any one or more of micro TRPs, TRPs equipped with a number of Tx and/or Rx and/or RF chains smaller than a threshold, TRPs equipped with power amplifiers with certain characteristics (e.g., max power being smaller than a threshold value), TRPs having max transmission power smaller than a threshold value, a set of TRPs in a reduced activity phase (e.g., transmitting RS/SSB/CSI-RS with a reduced periodicity), a set of TRPs following DTx/DRx pattern (e.g., having a periodic pattern with active and inactive intervals), a set of TRPs following a specific NES state (e.g., a low/reduced activity NES state), a set of opportunistically on TRPs, a set of TRPs providing capacity (e.g., the TRPs which are not for coverage purpose), a set of TRPs which changed their NES state based upon UE assistance (e.g., the TRPs currently in wake-up state due to UE request to wake up these TRPs), and a set of TRPs that changed their NES state based upon UE based trigger (e.g., UL WUS signal).

### Config of TRPs, SRIs, PL Reference RS(s)

The UE may be configured with (or may receive configuration information of) one or more TRPs to which the UE may transmit and/or from which the UE may receive. The UE may be configured with one or more TRPs for one or more cells. A cell may be a serving cell, secondary cell, or a supplementary cell.

The UE may be configured with at least one RS for the purpose of channel measurement. This RS may be denoted as a Channel Measurement Resource (CMR) and may include a CSI-RS, SSB, or other downlink RS transmitted from the TRP to the UE. A CMR may be configured or associated with a TCI state.

The UE may be configured with a CMR or RS group (RSG) that includes CMR indices transmitted from the same TRP. Each group may be identified by a CMR group index (e.g. group 1). The UE may be configured with one CMR group per TRP, and may receive a linkage between one CMR group index and another CMR group index, or between one RS index from one CMR group and another RS index from another group. The UE may determine that linked resources may be configured for multi-TRP CJT channel or CSI measurements.

The UE may be configured with (or receive configuration information of) one or more pathloss (PL) reference groups (e.g., sets) and/or one or more SRS groups, SRS resource indicator (SRI) or SRS resource sets.

A PL reference group may correspond to or be associated with a TRP. A PL reference group may include, identify, correspond to or be associated with one or more TCI states, SRIs, reference signal sets (e.g. CSI-RS set, SRI sets), control resource set (CORESET) index, and or reference signals (e.g. CSI-RS, SSB).

The UE may receive configuration information (e.g., for any configuration described herein) and use this to configure itself. The configuration information may be received from a gNB or TRP. For example, the UE may receive configuration information of one or more TRPs, one or more PL reference groups and/or one or more SRI sets. A UE may implicitly determine an association between a RS set/group and a TRP. For example, if the UE is configured with two SRS resource sets, then the UE may determine to transmit to TRP1 with SRS in the first resource set, and to TRP2 with SRS in the second resource set. The configuration information may be received via RRC signaling.

The UE may receive an indication of a primary and secondary TRP. When the UE is configured with multiple TRPs, it may determine that one of the TRP is the primary or anchor TRP. This designation may be based on a network configuration, or UE determination (e.g. received signal quality for one TRP is above all other TRP's received signal quality, or above a threshold).

In the embodiments of the present principles, “TRP”, “PL reference group”, “SRI group”, and “SRI set” may be used interchangeably, and the terms “set” and “group” may be used interchangeably.

Herein, for the brevity of discussion a coherent joint transmission system with 2 TRP is considered in some examples, but it will be understood that the present principles may equally be employed for cases with more than two TRPs. In this example case, one of the TRPs is considered as the primary TRP.

### Grant or Assignment Properties

Herein, a property of a grant or assignment may include of at least one of: a frequency allocation; an aspect of time allocation, such as a duration; a priority; a modulation and coding scheme; a transport block size; a number of spatial layers; a number of transport blocks; a TCI state, CRI or SRI, wherein a TCI state, CRI, or SRI may be for each UE's panel if multiple panels are used for a UL transmission; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); any parameter provided in a DCI, by MAC or by RRC for the scheduling the grant or assignment; whether the grant is for single-TRP transmission or multi-TRP transmission; whether the grant is for UL transmission from single UE panel (TxSP) or simultaneous UL transmission from multiple UE panels (STxMP); and whether the grant is for CJT or NCJT transmission

### CSI Components

The UE may report a subset of channel state information (CSI) components, where CSI components may correspond to at least a CSI-RS resource indicator (CRI), a SSB resource indicator (SSBRI), an indication of a panel used for reception at the UE (such as a panel identity or group identity), measurements such as Layer 1 reference signal received power (L1-RSRP), L1 signal to noise ratio (L1-SINR) taken from SSB or CSI-RS (e.g. cri-RSRP, cri-SINR, ssb-Index-RSRP, ssb-Index-SINR), or other channel state information such as at least rank indicator (RI), channel quality indicator (CQI), precoding matrix indicator (PMI), and Layer Index (LI).

### Codebook Types for CSI Reporting

The UE may be configured with a type of codebook for PMI reporting where a codebook determines a set of precoders. Each precoder indicates the amplitude and phase shift to apply to the modulation symbols before transmitting it on antenna elements/antenna ports.

In an embodiment, the UE is configured with a Type I codebook as described in NR Rel-15. The UE may report a selected beam and a phase indication for dual polarized beam combining. The beam information is wideband, while the phase may be reported per sub-band.

In another embodiment, the UE is configured with a Type II codebook as described in NR Rel-15. The Type II codebook may be based on a wideband CSI (W1) and a narrowband CSI (W2). In this process, W1 represents a preferred set of dual-polarized beams for each transmission layer. W1's structure may consist of a matrix with L1 columns corresponding to L1 spatial beams (i.e. L1 basis vectors), and R rows corresponding to the basis length. The set of spatial beams used for constructing W1 may be defined as a spatial basis of beams. W1 is based on a block-diagonal structure to represent the orthogonal polarization of transmit antenna set up. W1 CSI also includes wideband coefficient for indication of a preferred power setting per spatial beam. The W2 CSI may include additional amplitude information, delay information and co-phasing information for indication of preferred linear beam combining for cross-polarized antennas. The reporting of all or a subset of W2 CSI components may be per sub-band basis. The sub-band configuration is part of CSI reporting configuration.

For multi-TRP transmissions, the W2 may additionally include the amplitude, phase, delay etc. on TRP basis. These components may be reported separately per TRP or integrated within a combined PMI (W1 and W2).

The UE may be configured to select the type of the codebook based upon the configuration.

In an embodiment, the UE is configured to select the type of the codebook based upon number of beams, e.g., based upon indicated/configured or UE determined number of beams for CSI reporting.

The UE may be configured to apply compression techniques to the codebooks, e.g., compression in frequency domain [Rel-16], compression in spatial domain, compression in temporal domain etc.

In an embodiment, the UE is configured to report PMI for a pre-defined set of spatial domain basis vectors, e.g., Discrete Fourier Transform (DFT) based basis, as is used in Type I and Type II. The UE may be configured/indicated to use different basis instead of DFT basis.

In an embodiment, the Type II codebook is configured as a port-selection codebook, where the W1 matrix is used to indicate port indices from the measured CSI-RS resource associated with the CSI report. The UE may be configured to report PMI based upon port selection where the CSI-RS ports are used by the UE to determine a combination for PMI reporting.

### Configuration for On-Demand TRP Wake-Up Based Multi-TRP Transmissions

### UE Configuration for On-Demand TRP Wake-Up Based Multi-TRP Transmissions

The UE may be configured for multi-TRP operation in the downlink (DL) and/or in the uplink (UL) direction. The UE may be configured with the multi-TRP operation with on-demand TRP wake-up. In an embodiment, the on-demand TRP wake-up may be based upon UE assistance to the network for multi-TRP operation. In one design, the on-demand TRP wake-up may be based upon UE direct wake-up of one or more TRPs for multi-TRP operation. The UE may be configured to measure, compute and report CSI feedback for multi-TRP operation. The UE may be configured to determine PMI based upon channel state information (CSI) measurements where the CSI measurements are based upon the reference signals transmitted by one or multiple TRPs. The UE may be configured to assist the wake up or sleep of one or more TRPs for multi-TRP transmissions.

For multi-TRP transmissions with NES-aware TRP sleep/wake-up assistance, the UE may be configured with any one or more of: configuration of TRP sets for measurement, monitoring and wake-up/sleep; configurations of measurement resources from multiple TRPs; configurations for CSI/PMI computation; configurations for TRP sleep/wake-up assistance; WUS configuration; and configurations for NES aware CSI/PMI reporting. Details for these configurations will now be provided.

### UE Configuration of TRP Sets for Measurement, Monitoring and Wake-Up/Sleep

The UE may be configured with one or more sets of TRPs. The UE may be configured with one or more sets of TRPs to measure, monitor and wake-up/sleep. The UE may be configured to measure one or more sets of TRPs to provide CSI feedback to the network. The UE may be configured to measure and monitor one or more sets of TRPs for wake-up where the wake-up may be UE assisted, for example by UE providing an indication to the network which serves to request wake-up of one or more TRPs. The UE may be configured to measure and monitor one or more sets of TRPs for wake-up where the wake-up may be UE based, for example by UE transmitting a signal which triggers the wake-up of one or more TRPs. The UE may be configured to measure and monitor one or more sets of TRPs of different types and having different NES states. The UE may be configured to measure and monitor any one or more of the following sets of TRPs: a set of TRPs which are fully awake (e.g., transmitting RS/SSB/CSI-RS with normal periodicity); a set of TRPs in a reduced activity phase (e.g., transmitting RS/SSB/CSI-RS with a reduced periodicity); a set of TRPs following DTx/DRx pattern (e.g., having a periodic pattern with active and inactive intervals); a set of TRPs following a specific NES state; a set of macro TRPs; a set of micro TRPs; a set of always on TRPs; a set of opportunistically on TRPs; a set of TRPs providing coverage (e.g., which may be transmitting syncs signals periodically and may be used for initial access etc.); a set of TRPs providing capacity (e.g., the TRPs which are not for coverage purpose); a set of TRPs which changed their NES state based upon UE assistance, e.g., the TRPs currently in wake-up state due to UE request to wake up these TRPs; a set of TRPs which changed their NES state based upon UE based trigger, e.g., UL WUS signal.

The UE may receive configuration information where one or more of the sets of TRPs may be configured by the network by combining different types of TRPs, and different NES states. As an example, the UE may be configured to monitor TRPs which are macro TRPs in a particular NES state. In another example, the UE may be configured to monitor TRPs which are micro TRPs and in a reduced activity phase, and/or have a DTx/DRx pattern.

The UE may be configured to measure one or more sets of TRPs to one or more of: provide CSI feedback; provide CSI Feedback for multi-TRP transmissions; provide CSI Feedback for multi-TRP transmissions under a set of performance constraints/restrictions; provide an indication that a first set of TRPs (e.g., macro, or always on, or capacity TRPs etc.) are sufficient for multi-TRP transmissions, where the UE determination of the first set being sufficient may be based upon the UE determined PMI meeting performance constraints according to embodiments of the present principles; provide an indication that a first set of TRPs (e.g., macro, or always on, or capacity TRPs etc.) are NOT sufficient for multi-TRP transmissions, where the UE determination of the first set being sufficient or not may be based upon the UE determined PMI meeting performance constraints according to one of the embodiments in this disclosure; provide a wake-up/sleep assistance indication, e.g., the UE may provide a wake-up indication for one or more TRPs and/or the UE may provide a put to sleep indication for one or more TRPs; and transmit a wake-up/sleep signal which serves as trigger to wake-up one or more TRPs, or which serves as an indication that the TRP may be put to sleep e.g., based upon UE determination that the TRP is not needed by the UE for multi-TRP transmission; provide an indication that at least one or more TRPs belonging to the second set of TRPs need to change their NES state (e.g., wake up from sleep, change their NES state, change to full activity, stop/change DTx/DRx pattern etc.) for Multi-TRP transmissions, where the UE determination of the change of the NES state may be based upon the UE determined PMI meeting performance constraints according to embodiments of the present principles; provide the identities of one or more TRPs belonging to the second set of TRPs need to change their NES state (e.g., wake up from sleep, change their NES state, change to full activity, stop/change DTx/DRx pattern etc.) for multi-TRP transmissions, where the UE determination of the TRP identities may be according to embodiments of the present principles; and transmit wake-up signal(s) to one or more TRPs belonging to the second set of TRPs for which UE determines the need to change their NES state (e.g., wake up from sleep, change their NES state, change to full activity, stop/change DTx/DRx pattern etc.) for multi-TRP transmissions, where the UE determination of TRPs for wake-up and transmission of wake-up signal to those TRPs may be according to embodiments of the present principles.

### UE Configuration of Measurement Resources From Multiple TRPs

The UE may be configured by the network to measure and monitor one or more TRPs. The UE may be configured with reference signals (RSs) from one or multiple TRPs. The UE may be configured with one or more type of RSs, e.g., non-precoded RSs, pre-coded RSs, etc., for measurements. The RSs may be of type SSB, CSI-RS, PRS, etc. The UE may be configured with any one or more of the following properties for the configured RS: RS identity; resource mapping: time location (e.g., OFDM symbols) and frequency location (e.g., PRBs or REs) for the RS; periodicity of the resource (e.g., for periodic and semi-persistent resources); resource offset: The time offset to locate the start of the RS in time (e.g., in suitable units of slots and/or symbols, etc.); TRP identity for the TRP associated with the RS; Cell ID associated with the RS; resource set identity to which the RS resource belongs; bandwidth part associated with the RS; time domain behavior: aperiodic, semi-persistent, periodic; power control offset for PDSCH; power control offset against SSB; QCL information: e.g., by indicating one or multiple TCI states; scrambling Identity for the scrambling applied to the RS; sub-carrier spacing; cyclic prefix (e.g., normal or extended).

The network may provide additional information for configuration for RS resource sets, CSI resource sets or CSI resource groups where those configurations may be applicable to one TRP or a set of TRPs. These may include RS/CSI-RS Resource set identity; TRP identity associated with all the RS indicated within the group, the network may indicate one or more TRP identities; TRP type for each indicated TRP identity which may be indicated/configured through any one or more of micro TRP or macro TRP, coverage TRP or capacity TRP, UL/DL TRP, DL only TRP, UL only TRP etc., always-on TRP or opportunistically-on TRP, TRPs Equipped with Tx and/or Rx and/or RF chains larger or smaller than a threshold value, equipped with power amplifiers with certain characteristics, e.g., max power being larger/smaller than a threshold, TRPs with maximum transmission power being larger or smaller than a threshold value; NES state, or current NES state, that may provide an indication of network energy saving state of the resource set (in an embodiment, the NES state is associated with the TRP; in another embodiment, the NES state may be determined by the UE based upon the TRP type, e.g., one NES state for micro TRP, and another NES state for macro TRP; target NES state that may provide an indication of the desired NES state under which the network wants to operate this resource set and/or associated one or more TRPs (in an embodiment, the UE may determine the target NES state based upon the type of TRPs, for example, the UE may determine a desired NES state of “Opportunistically ON” or “sleep” for micro TRPs, whereas a state of “always ON” for macro TRPs, etc.; power control offset associated with the TRP if specified (in an embodiment, the UE's may know default values to apply which may be based upon the type of the TRP, e.g., the TRP being micro TRP or macro TRP; cell ID; list of RS resources belonging to the resource set: list of RS identities; mapping of RS resource IDs with the TRP ID: when the resource set is configured for more than one TRP, the network may configure the mapping of RS resources and TRPs (in an embodiment, the mapping may be configured as part of the RS resource configuration); and time domain behavior: aperiodic, semi-persistent, periodic.

The network may provide the linkage/pairing of RS resources for CSI reporting for the purpose of multi-TRP joint transmissions, e.g., coherent joint transmissions. In one design, the network may configure different CSI resource sets for different TRPs and may provide linkage of resources from one resource set to the other. In one design, there may be implicit linkage or pairing of resources for different resource sets.

In one design, the network may provide the configuration for linking/pairing RS resources for all TRPs. The pairing may be between all the configured TRPs, which are candidates for joint transmissions, e.g., CJT. The RS pairing may be configured among a subset of TRPs, e.g., RS pairing sets for 2 TRPs, 3 TRPs, 4 TRPs etc.

### UE Configuration for CSI Feedback and PMI Determination for Multi-TRP Transmissions

The UE may be configured to provide CSI feedback based upon measurements. The UE may be configured to provide CSI feedback based upon one or more sets of TRPs where the configurations for one or more sets of TRPs is according to one of the embodiments in this disclosure. The UE may be configured to estimate and provide CSI feedback, e.g., PMI. The UE may be configured to determine PMI based upon channel state information (CSI) measurements from a set of TRPs. The UE may be configured to determine PMI under a set of performance constraints. The UE may be configured with any one or more of the following performance restrictions/constraints: target Rank R (e.g., the reported rank of the pre-coding matrix should not be less than a threshold R); quality/reliability constraint indicating that the reported PMI should have quality better than a given threshold value, e.g., the CQI associated with the reported pre-coding matrix should exceed a threshold value; throughput constraint indicating that the reported PMI should have throughput better than a given threshold value, e.g., the CQI associated with the reported pre-coding matrix should exceed a threshold value; data rate constraint indicating that the reported PMI should have (estimated/expected) data rate better than a given threshold value where the UE may estimate the data rate for a PMI based upon configuration/indication; a number n of joint pre-coding matrices to report where n may be configured as the min/max or precise number of reported pre-coding matrices (e.g., 1, 2, . . . ).

### UE Configuration for TRP Sleep/Wake-Up Criterion/Conditions

The UE may be configured to monitor one or more sets of TRPs. The UE may be configured to monitor and measure one or more sets of TRPs for UE determination of one or more TRPs being candidate for a change of NES state. The UE may be configured to determine one or more TRPs for any one or more of: TRP Wake up: the UE may determine that one or more TRPs of a configured/determined TRP set need to be woken up for multi-TRP transmissions; TRP put to sleep: the UE may determine that one or more TRPs of a configured/determined TRP set may be put to sleep (e.g., go back to sleep), e.g., based upon the UE determination that these TRPs are not needed for multi-TRP transmissions (in an embodiment, the UE determination for TRP put to sleep is based upon a timer, e.g., based upon the expiry of a timer, where the timer may be started when the UE detects the TRP waking up from a sleep sate, or changing NES state); TRP change of NES state: the UE may determine that one or more TRPs of a configured/determined TRP set need to change their NES state, e.g., change their activity pattern, change their sleep cycle, change their DTx/DRx pattern, change their spatial/power domain patterns, etc. (in an embodiment, the UE may determine that at least one TRP from a set e.g., a set of sleeping TRPs, need to change their NES state to active state; in another embodiment, the UE may determine that one or more specific TRPs need to change their NES state for multi-TRP transmissions; in a further embodiment, the UE may determine that one or more TRPs of a specific type/set may go to sleep, e.g., based upon UE determination that they are no longer needed for multi-TRP transmissions).

The UE determination of one or more TRPs from one or more TRP sets being candidate for change of NES state may be based upon measurements. The UE determination of one or more TRPs from a given TRP set being candidate for change of NES state may be based upon the measurements configured for the same set of TRPs, on a different set of TRPs, or both same and different one or more sets of TRPs.

The UE may be configured with the wake-up/sleep conditions for one or more TRPs. The TRPs belong to a set of TRPs or different sets of TRPs. The UE may be configured with any one or more of the following conditions as wake-up/sleep conditions: the UE may be configured to determine one or more TRPs of a second TRP set for wake-up if estimated PMI over a first set of TRPs does not meet the performance requirements according to the configuration, or if the UE determined loss for the estimated PMI over the first set of TRPs is larger than a configured threshold; the UE may be configured to determine one or more TRPs of a second TRP set for wake-up if the signal measurements over the second set of TRPs are larger than a configured threshold; the UE may be configured to determine one or more TRPs of a second TRP set for wake-up if the signal measurements over any one or more of the second set of TRPs are larger than the signal measurements over any one or more TRPs of a first TRP set; the UE may be configured to determine one or more TRPs of a second TRP set for wake-up if the signal measurements over any one or more of the second set of TRPs are larger than the signal measurements of the TRPs in UE estimated PMI matrix where the UE estimates PMI matrix over the signal measurements of a first TRP set; the UE may be configured to determine one or more TRPs of a second TRP set for sleep (e.g., put to sleep) if estimated PMI over a first set of TRPs meets the performance requirements according to the configuration, or if the UE determined loss for the estimated PMI over the first set of TRPs is smaller than a configured threshold; the UE may be configured to determine one or more TRPs of a second TRP set for sleep (e.g., put to sleep) if the signal measurements over the second set of TRPs are smaller than a configured threshold; the UE may be configured to determine one or more TRPs of a second TRP set for sleep (e.g., put to sleep) if those one or more TRPs were woken-up by the UE either directly (e.g., by transmitting a WUS signal or indirectly by requesting the network); and the UE may be configured to determine one or more TRPs of a second TRP set for sleep (e.g., put to sleep) if those one or more TRPs were woken-up by UE and after the expiry of a timer (e.g., these TRPs have been awake for at least a certain configured duration of time).

The UE may be configured to treat any/all TRP wake-up conditions as TRP sleep conditions when the wake-up conditions are not fulfilled.

The UE may be configured to treat any/all sleep conditions as wake-up conditions when the sleep conditions are not fulfilled.

The UE may perform an action when the wake-up conditions get satisfied for one or more TRPs. The UE configuration upon wake-up conditions getting satisfied for one or more TRPs may be any one or more of provide a TRP wake-up indication to the serving cell or serving TRP; provide a TRP wake-up indication to the serving cell or serving TRP with the identities of the TRPs for which wake-up conditions get satisfied at the UE; and transmit a signal, e.g., a wake-up signal (WUS) to one or more TRPs for which wake-up conditions are satisfied.

The UE may perform an action when the sleep conditions are satisfied for one or more TRPs. The UE configuration upon sleep conditions getting satisfied for one or more TRPs may be one or more of provide a TRP sleep (e.g., put to sleep) indication to the serving cell or serving TRP; provide a TRP sleep (e.g., put to sleep) indication to the serving cell or serving TRP with the identities of the TRPs for which sleep conditions get satisfied at the UE; and transmit a signal, e.g., a “sleep” signal to one or more TRPs for which sleep conditions get satisfied, where the “sleep” signal may be a signal similar to WUS signal (in an embodiment, the “sleep” signal is the same signal as the WUS signal but transmitted to a TRP which is ON or fully awake or in a specific NES state, where the transmission of sleep/WUS signal to a fully on/awake TRP may imply UE indicating that the relevant TRP may go back to sleep, or at least not needed by the UE transmitting the sleep signal.

### UE Configuration of WUS Signals for TRP Wake-Up/Sleep Triggers

The UE may be configured to wake-up/sleep one or more TRPs. The UE may be configured to determine the target TRPs for wake-up/sleep based upon one or more embodiments in this disclosure. The UE may be configured to wake-up one or more TRPs of by transmitting a signal, e.g., a wake-up signal. The UE may be configured with a pre-defined signaling configuration to request wake-up of one or more TRPs. The UE may be configured to notify a “sleep” indication to one or more TRPs through the transmission of a sleep signal. In an embodiment, the “sleep” signal is configured to be the same as WUS signal. The sleep indication may imply that the target TRP is not needed, at least, by the UE transmitting the signal, and the TRP can be put to sleep, e.g., up to the network decision.

In an embodiment, the UE is provided with the WUS configurations associated with one or more TRPs by its serving cell, or by neighboring cells.

In an embodiment, the UE receives the WUS configuration for one or more cells through system information received from the network, e.g., by reading SIBs from its serving/camped cells.

In an embodiment, a set of configurations are (pre-)specified known to the UEs for use as WUS to wake up one or more TRPs. The UE determination of a suitable configuration for a given TRP may be based upon the type of the TRP, and/or based upon the current NES state of the TRP, and/or based upon the UE location, and/or based upon the TRP location etc.

A WUS configuration to wake up or put to sleep one or more TRPs (e.g. by transmitting WUS or RACH) may include one or more of PRACH configuration for requesting wake-up (and/or put to sleep) of a (one, any, a specific) TRP, including PRACH partition, PRACH resource (e.g. RACH occasions and/or preamble indices), power control parameters, PRACH tx power, and a subset of parameters typically in RACH config common; SSB-to RO mapping tables for the cells/TRPs performing beam sweep with more than one SSB beam, WUS repetition configuration if not known; default uplink BWP and a timing for WUS transmission; trigger conditions for WUS transmission (in an embodiment, the WUS configuration includes the trigger conditions when the UE may transmit the WUS to wake-up/sleep the TRP; in another embodiment, the UE has a separate configuration to determine TRP wake-up/sleep based upon configured conditions according to embodiments of the present principles).

The WUS configuration may be UE common, e.g., all the UEs may be configured with the same WUS configurations for one or more TRPs.

The WUS configuration may be UE specific, e.g., every UE may be configured with a unique WUS configurations for one or more TRPs.

The WUS configuration may have different TRP scope. In an embodiment, there may be a unique configuration for a TRP. In another embodiment, there may be a single configuration for all the TRPs of a set of TRPs.

### UE Configuration for On-Demand TRP Wake-Up Based CSI Reporting

The UE may be configured to report CSI. The UE may be configured to report CSI for multi-TRP transmissions. The UE may be configured to report CSI with on-demand TRP wake-up assistance. The UE may be configured to report one or more of the following for CSI reporting with on-demand TRP wake-up assistance: CQI and associated RS resource where CQI is computed; RI and associated RS resource where RI is computed; PMI and associated RS resource where PMI is computed; RSRP/RSRQ/SINR for the RS resources for which any of the CQI/RI/PMI is reported; and on-demand TRP Wake-up/sleep Indication.

When the UE reports the PMI, it may be configured to report any one or more of PMI based upon Type I codebook with parameters needed to determine the PMI at the network, e.g., beam, amplitude, phase; PMI based upon Type II codebook with relevant parameters needed to determine the PMI at the network, e.g., beams, beam combining parameters, amplitude, phase, etc.; and PMI based upon Type II codebook with port selection with relevant parameters needed to determine the PMI at the network, e.g., ports, port combining parameters, amplitude, phase, etc.

The UE may provide an on-demand TRP wake-up indication based upon configuration. In an embodiment, the UE is configured to provide TRP wake-up indication with every CSI report. In an embodiment, the UE provides TRP wake-up indication with a periodicity different than the CSI report periodicity. For example, the UE may be configured to provide TRP wake-up indication with a reduced periodicity compared to CSI reporting periodicity. In an embodiment, the UE is configured/indicated/signaled the on-demand TRP wake-up indication explicitly. In an embodiment, the UE determines the on-demand TRP wake-up indication implicitly, e.g., based upon the configuration of RSs associated with TRPs or TRPs sets which are candidates for wake-up. In an embodiment, the UE is configured to provide TPR wake-up indication only when UE determines a need to change the NES state of one or more TRPs according to one of the embodiments in this disclosure.

The UE may be configured to report “n” PMI determined according to the configuration where “n” may be a configuration parameter that may take an integer value, e.g., 1, 2, etc.

The UE may be configured to report on-demand TRP wake-up/sleep indication. The on-demand TRP wake-up/sleep indication may include any one or more of an indication notifying the network that the PMI computed over a first set of TRPs satisfies the performance requirements; an indication notifying the network that the PMI computed over a first set of TRPs does not satisfy the performance requirements; a request to wake-up a TRP/any TRP from a second set of TRPs where the UE may be configured with the second set to monitor for on-demand TRP wake-up; a request to put to sleep a TRP from a second set of TRPs where the UE may be configured with the second set to monitor for on-demand TRP wake-up, where the UE indication may be based upon the UE determination that the UE does not need the TRP anymore for multi-TRP transmissions; a request to wake-up one or more TRPs from a second set of TRPs where the UE may be configured with the second set to monitor for on-demand TRP wake-up, and the UE may provide the TRP identities that it requests the wake-up from the network; an indication to put to sleep one or more TRPs from a second set of TRPs where the UE may be configured with the second set to monitor for on-demand TRP wake-up/sleep, and the UE may provide the TRP identities that it provides the indication to the network that they can be put back to sleep; an indication to the network that the UE has sent, is sending or will send a wake-up signal to one or more TRPs from a second set of TRPs where the UE may be configured with the second set to monitor for on-demand TRP wake-up, and the UE may be configured/signaled/determined the wake-up configurations for the relevant TRPs; an indication to the network that the UE has woken up one or more TRPs from a second set of TRPs for multi-TRP transmission, e.g., through UE transmission of UL WUS signals associated with the wake-up of those one or more TRPs; an indication to the network that the UE woke up one or more TRPs from a second set of TRPs for multi-TRP transmission, e.g., through UE transmission of UL WUS signals associated with the wake-up of those one or more TRPs, but these TRPs are no longer needed and can be put to sleep; and an indication to the network that the UE failed to wake-up one or more TRPs from a second set of TRPs for multi-TRP transmission, e.g., through UE transmission of UL WUS signals associated with the wake-up of those one or more TRPs and UE detection of TRPs not waking up.

### UE Actions for On-Demand TRP Wake-Up for Multi-TRP Transmissions

### Measurement of RSs From One or More Set of TRPs

The UE may receive, and measure RSs. The UE may receive, and measure RSs transmitted by one or more TRPs, belonging to one or more sets of TRPs. The UE may determine the parameters to receive and measure RSs from the RS configuration. The UE may be configured with different types of RSs associated with different sets of TRPs, e.g., one set of TRPs configured with CSI-RS signals for measurements, and a second set of TRPs configured with SSB signals. The relevant parameters to receive and measure RSs may include of one or more of resource mapping, i.e., time location (e.g., OFDM symbols) and frequency location (e.g., PRBs or Res) for the RS; RS type: SSB, CSI-RS, PRS, TRS, etc.; periodicity of the resource (e.g., for periodic and semi-persistent resources); resource offset: The time offset to locate the start of the RS in time (e.g., in suitable units of slots and/or symbols, etc.); TRP identity of the TRP associated with the RS; cell ID associated with the RS; identity of the resource set to which the RS resource belongs; bandwidth part associated with the RS; time domain behavior: aperiodic, semi-persistent, periodic; power control offset for PDSCH; power control offset against SSB; QCL information: e.g., indicating one or multiple TCI states; scrambling Identity for the scrambling applied to the RS; sub-carrier spacing; and cyclic prefix (e.g., normal or extended).

The UE may receive and measure one set of TRPs to compute PMI from multiple TRPs of the set of TRPs according to embodiments of the present principles. The UE measurement and computation for PMI may follow a first periodicity where the first periodicity may be based upon the CSI reporting periodicity or based upon the periodicity of the signals of the TRP set over which the UE is configured to compute PMI.

The UE may receive and measure one set of TRPs. The UE may estimate quantities, e.g., RSRP, RSRQ, SINR etc. based upon the measurements over one or more TRPs from a given set of TRPs. The UE may use the measurements and measurements quantities (e.g., RSRP, RSRQ, SINR, etc.) of one or more TRPs to determine the TRPs from a given TRP set with a given criterion, e.g., one or more TRPs with the largest received signal power, and/or one or more TRPs with largest estimated RSRP, and/or one or more TRPs with the largest RSRP/RSRP/SINR etc. The TRP set may be configured based upon the type of TRPs, e.g., micro TRPs. The TRP set may be configured based upon the (current) NES state of TRPs, e.g., TRPs in a given NES state, which may be DTx/DRx, sleeping TRPs, or TRPs with reduced signal transmission periodicity etc. The UE measurements and computation for measurement quantities, e.g., RSRP, RSRQ, SINR, etc., may follow a second periodicity where the second periodicity may be based upon the on-demand TRP wake-up configuration or based upon the periodicity of the signals of the TRP set over which the UE is configured to run on-demand TRP wake-up procedure.

In an embodiment, the UE is configured to measure the signals and compute measurement quantities (e.g., RSRP, RSRQ, SINR etc.) of over a set of TRPs only if measurements over another set of TRPs result in a PMI that does not satisfy the performance constraints/restrictions, or the estimated PMI has a loss larger than a threshold value.

Ranking/Ordering of TRPs from a set of TRPs

The UE may perform ordering or ranking of the TRPs. The UE may perform ordering or ranking of the TRPs from a set of TRPs. The set of TRPs may be configured/indicated/signaled to the UE. The UE may be configured with/signaled/indicated the set of TRPs to perform ranking where the set of TRPs may correspond to a set of TRPs of a specific type, and/or a set of TRPs in a specific NES state, etc. The UE may be configured to perform ordering or ranking of the TRPs in a set based upon the measurements of those TRPs. The UE may perform ordering or ranking of the TRPs in a set based upon any one or more of estimated/determined/expected RSRP/RSRQ/SINR, where the UE estimation/determination/expectation of RSRP/RSRQ/SINR may be based upon the RS signals measurements from a TRP according to the configurations; estimated/determined/signaled TRP location, where the UE may be configured to prioritize some locations over the other, or simply may consider some locations and associated TRPs for ranking and may not consider others; estimated/determined/signaled TRP load; and estimated/determined/signaled NES state of the TRP, where the UE may be configured to rank/order TRPs based upon NES state such that certain NES states may be considered acceptable for ranking (e.g., ranked higher), while certain other NES states are not considered during ranking, or those TRPs not considered available for ranking.

In an embodiment, the UE uses the ranked/ordered list of TRPs from a set of TRPs for evaluation of on-demand TRP wake-up.

In an embodiment, the UE performs ranking/ordering of TRPs in one set of TRPs only if it determines PMI associated with another set of TRPs being not sufficient, where the UE determination of PMI for a set of TRPs being sufficient or not is according to embodiments of the present principles.

### Determination of PMI Based Upon a Set of TRPs

The UE may determine a precoding matrix. The UE may determine a precoding matrix information (PMI) based upon the CSI received from one or multiple TRPs, belonging to a configured set of TRPs. The UE may determine a PMI for joint transmission from multiple TRPs, belonging to one configured set of TRPs. The UE may determine a PMI for joint transmission (e.g., coherent joint transmission) from multiple TRPs based upon the RSs transmitted by these TRPs. The UE receives and measures the RSs from one or more TRPs of the TRP set based upon the configuration received for the RS resources transmitted by these TRPs according to one of the embodiments in this disclosure. The UE may determine a PMI based upon the measurements, where the PMI determination is according to the performance constraints/restrictions (e.g., over rank, CQI, etc.). The UE configuration to determine PMI under a set of performance constraints/restrictions is according to embodiments of the present principles.

In an embodiment, a UE is configured with more than one sets of TRPs and associated RS resources. The UE may determine one PMI for each set of TRPs. In an embodiment, the UE may determine one PMI jointly over all sets of TRPs. The UE, based upon configuration, may determine one PMI for each subset of the TRP sets.

In an embodiment, the UE determination of PMI includes the measurements made over one set of TRPs only.

In an embodiment, the UE determination of PMI includes the measurements made over one set of TRPs and the TRPs from another set which have changed NES state based upon UE determination of wake-up/sleep for those TRPs, e.g., by the UE providing assistance information for TRP wake-up to the network, or by UE transmitting a WUS signal directly to one or more TRPs.

### UE Estimation of Performance Loss for a Computed PMI

The UE may estimate a loss for a PMI matrix. The UE may estimate a loss for a computed PMI matrix where it computes the PMI matrix based upon the measurements. The UE measurements may correspond to measurements of RSs (e.g., CSI-RS) transmitted by a set of TRPs. The set of TRPs may be a set of macro TRPs, always ON TRPs, a set of TRPs in a given NES state, or a set of TRPs configured to the UE for PMI determination. The configuration of one or more sets of TRPs, and configuration of measurement resources for CSI estimation may be according to the embodiments of the present principles. The UE determination of PMI matrix is according to the embodiments of the present principles.

The UE may be configured to estimate the loss for a computed PMI based upon any one or more of loss in Rank against a threshold value, e.g., a configured threshold value; loss in throughput against a threshold value, e.g., a configured threshold value; and loss in Quality/Reliability/CQI for the computed PMI against a threshold value, e.g., a configured threshold value.

The UE may be configured to estimate the loss for a computed PMI against a reference. In an embodiment, the reference may correspond to a configuration parameter or threshold value. For example, the UE may be configured to determine the loss for the computed PMI based upon the rank where a target rank may be provided as part of the configuration. In this case, the UE may determine the loss in rank with computed PMI based upon the rank of the determined PMI and the configured target rank. The UE may determine the loss in rank, in this example, by subtracting the rank of the computed PMI from the configured target rank.

### UE Determination/Evaluation of TRP Wake-Up/Sleep Condition

The UE may determine and/or evaluate a condition for a TRP wake-up and/or sleep. The UE may determine and/or evaluate a condition for a TRP wake-up/sleep based upon the configuration for multi-TRP transmission.

The UE may determine and/or evaluate a TRP wake-up/sleep condition for a TRP based upon the TRP belonging to a specific set of TRPs. In an embodiment, the UE is configured to determine and/or evaluate the TRP wake-up/sleep condition for the TRPs belonging to a set of micro TRPs. In an embodiment, the UE is configured to determine and/or evaluate the TRP wake-up/sleep condition for the TRPs belonging to a set of macro TRPs.

The UE may determine and/or evaluate the TRP wake-up/sleep condition for the TRPs (e.g., TRPs in a set) based upon their NES state. In an embodiment, the UE evaluates the TRP wake-up conditions for the TRPs currently in the low activity NES state, or in DTx/DRx state or in sleep sate, or currently applying some form of NES adaptations e.g., in power/spatial/time/frequency domain. In an embodiment, the UE evaluates the TRP sleep conditions for the TRPs currently in the high activity NES state, or in fully ON state, or currently not applying any form of NES adaptations e.g., in power/spatial/time/frequency domain.

The UE may determine and/or evaluate the TRP wake-up/sleep condition for the TRPs (e.g., TRPs in a set) based upon UE location and/or TRP location and/or the distance between the UE and the TRP.

The UE may determine and/or evaluate the TRP wake-up/sleep condition for the TRPs (e.g., TRPs in a set) based upon the measurements made over the signals transmitted by the TRPs. The UE may determine the wake-up/sleep condition for a TRP based upon the measurements made over the TRP being larger or smaller than a threshold. In one example, the UE may determine the wake-up conditions for a TRP if the measured RSRP over the RS (e.g., SSB/CSI-RS etc.) from this TRP exceeds a configured threshold. In an embodiment, the UE determines the sleep condition for a TRP if the measured RSRP over the RS (e.g., SSB/CSI-RS etc.) from this TRP falls below a configured threshold.

The UE may determine and/or evaluate the TRP wake-up/sleep condition for a TRPs (e.g., TRPs in a set) based upon the measurements made over the signals transmitted by the TRPs in a different set. For example, if the UE is configured to determine PMI over a first set of TRPs, and the UE determines the PMI over the first set of TRPs does not meet the performance constraints/restrictions, the UE may determine to measure and evaluate the wake-up conditions for a (one or any or all) TRP of a second configured set of TRPs.

The UE may determine and/or evaluate the TRP wake-up/sleep condition for a TRPs (e.g., TRPs in a second set) based upon the measurements made over the signals transmitted by the TRPs in a first set and based upon the measurements made over the signals transmitted by the TRPs in the second set. For example, if the UE is configured to determine PMI over the first set of TRPs, and the UE estimates a PMI based upon the signal measurements over the first set of TRPs. The UE may determine the wake-up condition for a TRP in a second set based upon the signal measurements of any one or more TRPs in the second set being larger than the signal measurements of any TRP of the first set which is part of UE estimated PMI for multi-TRP transmission.

In an embodiment, if the UE determines that the PMI over the first set of TRPs meets the performance constraints/restrictions, the UE determines to stop measuring and evaluate the wake-up conditions for a (one or any or all) TRP of a second configured set of TRPs.

In an embodiment, if the UE determines that the TRPs in the UE estimated PMI over the first set of TRPs have signal measurements larger than the second set of TRPs, the UE determines to stop measuring and evaluate the wake-up conditions for a (one or any or all) TRP of a second configured set of TRPs. The UE may determine to stop measuring and evaluating the TRPs of the second set for a configured/known/signaled duration. After this duration, the UE may start again measuring, monitoring the signals from the second set of TRPs.

In an embodiment, if the UE determines that the PMI over the first set of TRPs meets the performance constraints/restrictions, the UE determines to indicate to the network that a (one, any or all) TRP of the second set may be put to sleep. In an embodiment, the UE may be configured to provide “put to sleep” indication only for the TRPs that it requested wake-up earlier, or it woke-up those TRPs by requesting to the network, or by transmitting a signal, e.g., UL WUS signal, directly to those TRPs.

In an embodiment, the UE is configured to provide “put to sleep” indication only for the TRPs that have been awake for a certain duration of a time, e.g., based upon expiry of a timer at the UE. The duration of time that these TRPs have been awake may be determined by the UE from the time instant when the UE transmitted WUS to these TRPs, or provided wake-up assistance to the network for these TRPs, or based upon the time instant that UE detected these TRPs awake, e.g., based upon signals received from these TRPs.

### UE Selection of TRP Wake-Up/Sleep Candidates

The UE may perform selection over TRP wake-up/sleep candidates. The UE may perform selection (or sub-selection) over TRP wake-up/sleep candidates where the TRP wake-up/sleep candidates are the TRPs for which conditions for TRP wake-up/sleep get satisfied according to one of the embodiments in this disclosure. The UE may perform selection of TRP wake-up/sleep candidates based upon any one or more of number of TRP, i.e. a maximum number of TRPs that the UE can indicate to the network for wake-up or send WUS signal directly for wake-up; type of TRP, i.e. one or more TRPs of a given TRP type for wake-up/sleep when those TRPs satisfy wake-up/sleep conditions (in an embodiment, different TRP types (e.g., micro/macro, alwaysOn/opportunisticallyOn etc.) are assigned different priorities and the UE is configured to select the TRPs based upon the priorities associated with the types of TRPs); and NES state for the TRPs, i.e. one or more TRPs of a given NES state for wake-up/sleep when those TRPs satisfy wake-up/sleep conditions (in an embodiment, the UE is configured with different priorities associated with different NES states, and the UE may select the TRPs based upon the priorities of their detected/estimated/signaled NES states).

### UE Transmission of WUS Signal for TRP Wake-Up

The UE may transmit WUS signal to wake-up a TRP. The UE may transmit a WUS signal to a TRP for which TRP wake-up conditions get satisfied according to one of the embodiments in this disclosure. The UE may select the appropriate configuration for the TRP satisfying the wake-up conditions. According to the selected configuration, and the measurements over the TRP signals, the UE selects suitable time-frequency resource to transmit WUS signals. The UE may perform repetitions for WUS transmissions.

The UE may transmit a “sleep” signal to put-to-sleep a TRP. The UE may transmit a sleep signal to a TRP for which TRP sleep conditions get satisfied. The UE may be configured with a sleep signal same as the WUS signal for one or more TRPs.

### UE Confirmation for TRP Wake Up

The UE may confirm the wake-up of a TRP. In an embodiment, the UE confirms the wake-up of one or more TRPs based upon UE transmission of WUS signal to the TRP. In an embodiment, the UE confirms the wake-up of one or more TRPs based upon UE assistance of TRP wake up to the network.

The UE may confirm the wake-up of a TRP based upon any one or more of change of RS periodicities transmitted by the TRP, wherein the UE may detect the TRP wake up by detecting its transmissions with a different periodicity after the TRP wake-up assistance or WUS transmission (as an example, the UE may detect that the TRP is transmitting RS (e.g., SSB or CSI-RS) with an updated periodicity compared to while it was in sleep mode); change of RS transmitted by the TRP, wherein the UE may detect the TRP wake up by detecting TRP transmissions with a different RS after wake-up, e.g., a TRP may start to transmit CSI-RS after wake-up while it may be transmitting only SSBs prior to wake-up; and change of TRP NES state, wherein the UE may detect the NES state of the TRP, implicitly or explicitly, and wherein the implicit detection may be based upon detection of some signals or some properties of the signals transmitted by the TRP, and wherein the explicit detection of the NES state may be based upon NES state indication reception through the same or a different TRPs.

### UE Enabling UE Identification at the TRP

The UE may inform a TRP of its UE identity. The UE may enable its identification at the TRP. The UE may inform the TRP of its identity when the UE wakes it up through transmission of a WUS signal. The UE may inform TRP of its identity based upon any one or more of: through the transmission of WUS signal, e.g., when the UE is configured/assigned/indicated/signaled dedicated WUS configuration to wake up one or more TRPs, and based upon detecting a WUS signal, the TRP may determine the UE identity; through contention resolution, wherein the TRP may identify the UE identity transmitting the WUS signal based upon the contention resolution phase, for example when the WUS configuration includes of the RACH procedure including the contention resolution phase, e.g., through Msg3 or MsgA transmission; and through indication to serving cell/TRPs, wherein the UE may wake-up a TRP by transmitting WUS and also transmit to its serving cell/TRP an indication of the TRP identity to which UE transmitted WUS signal, which may allow UE identification at the TRP as this UE woke up the TRP.

### UE Reporting of Multi-TRP PMI and On-Demand TRP Wake-Up

The UE may report feedback based upon measurements over one or more sets of TRPs. The UE measurements over one or more sets of TRPs may be according to the measurement configuration and measurement resources configured for the respective TRPs. The UE reported feedback may correspond to the CSI feedback and the TRP wake-up/sleep indication. The CSI feedback may include of any of the rank indication, layer indication, CQI, PMI, and additional parameters for CSI feedback according to the configuration. These may include PMI determination based upon a specific type of codebook, e.g., Type I codebook, Type II codebook, Type II codebook with port selection etc. The CSI feedback may include the identities of TRPs which are part of the joint PMI for multi-TRP transmission.

The TRP wake-up/sleep indication may be in the form of a request, a form of assistance information for TRP sleep/wake-up, or an information message concerning the TRPs for which UE conditions for wake-up/sleep get satisfied. The on-demand TRP wake-up/sleep indication may include one or more of an indication notifying the network that the PMI computed over a first set of TRPs satisfies the performance requirements; an indication notifying the network that the PMI computed over a first set of TRPs does not satisfy the performance requirements; a request to wake-up a TRP/any TRP from a second set of TRPs, e.g., when the second set of TRPs may correspond to sleeping TRPs, micro TRPs, micro TRPs in sleep state etc.; a request to put to sleep a TRP from a second set of TRPs where the UE may be configured with the second set for opportunistic transmissions, and the UE indication may be based upon the UE determination that the UE does not need the TRP from the second set anymore for multi-TRP transmissions, e.g., based upon the measurements of signals transmitted by first and/or second set of TRPs; a request to wake-up one or more TRPs from a second set of TRPs where the UE may be configured with the second set to monitor for on-demand TRP wake-up, and the UE may provide the TRP identities that it requests the wake-up from the network, wherein the TRP identities may correspond to the TRPs for which the wake-up conditions are satisfied at the UE; an indication to put to sleep one or more TRPs from a second set of TRPs where the UE may be configured with the second set to monitor for on-demand TRP wake-up/sleep, and the UE may provide the TRP identities that it provides the indication to the network that they can be put back to sleep, wherein the TRP identities may correspond to the TRPs for which the sleep conditions are satisfied at the UE; an indication to the network that the UE has sent, is sending or will send wake-up signal to one or more TRPs from a second set of TRPs where the UE may be configured with the second set to monitor for on-demand TRP wake-up, and the UE may be configured/signaled/determined the wake-up signal configurations for the relevant TRPs, wherein the UE indication for the TRPs corresponds to the TRPs for which UE has evaluated the wake-up conditions and the wake-up conditions are satisfied at the UE; an indication to the network that the UE has woken up one or more TRPs from a second set of TRPs for multi-TRP transmission, e.g., through UE transmission of UL WUS signals associated with the wake-up of those one or more TRPs; an indication to the network that the UE woke-up one or more TRPs from a second set of TRPs for multi-TRP transmission, e.g., through UE transmission of UL WUS signals associated with the wake-up of those one or more TRPs, but these TRPs are no longer needed and can be put to sleep; and an indication to the network that the UE failed to wake up one or more TRPs from a second set of TRPs for multi-TRP transmission, e.g., through UE transmission of UL WUS signals associated with the wake-up of those one or more TRPs and UE detection of TRPs not waking up.

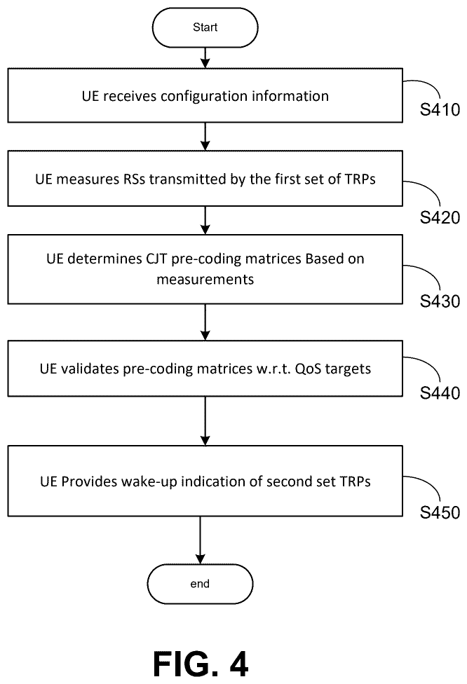

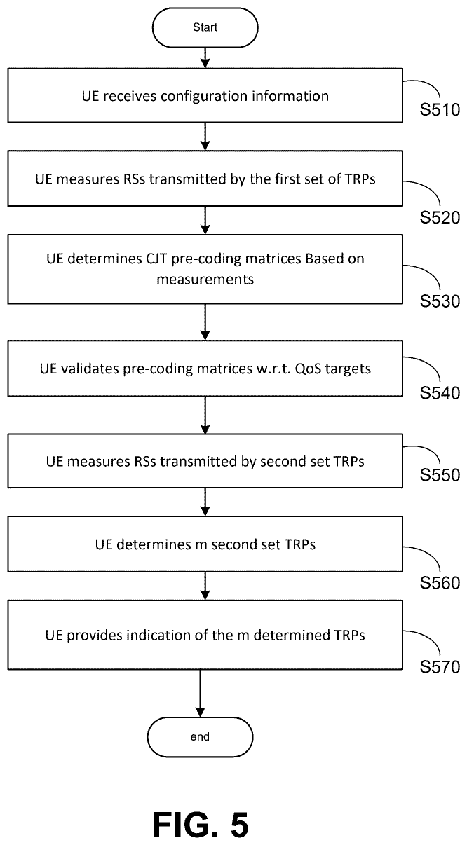

FIG. 4 illustrates a second method according to an embodiment of the present principles. Briefly speaking, in at least an embodiment the second method is for UE provision of a TRP wake-up indication to the network.

Briefly put, for coherent joint transmissions in heterogeneous TRP deployments including macro (always on) TRPs and micro (opportunistically on) TRPs, a UE measures the CSI-RS from a set of macro TRPs, computes joint pre-coding matrices over macro TRPs to achieve a given QoS (rank/throughput etc.), and, in case the UE cannot determine any pre-coding matrix meeting the QoS, requests wake up of micro TRPs.

In step S410, the UE receives network configuration information for coherent joint transmission from M1 macro TRPs and m1 micro TRPs, including of one or more of: one or more RSs (e.g., CSI-RSs) for CSI measurements and feedback associated with each TRP, a first set of TRPs for CSI measurements (e.g., macro or currently ON), rank restriction (e.g., the overall rank of the reported pre-coding matrix exceeding a threshold L), reliability restriction (e.g., the CQI associated with the reported pre-coding matrix exceeding a threshold C), and a number n of joint pre-coding matrices to report where n may be configured as the minimum, maximum or the precise number of reported matrices. The UE can use the received network configuration information to configure itself.

In step S420, the UE receives and measures RSs transmitted by the first set of TRPs, as per the configuration.

In step S430, the UE determines a set of (e.g., best) pre-coding matrices for coherent joint transmission to achieve the QoS (rank/reliability etc.), based upon the measurements.

In step S440, the UE validates the determined pre-coding matrices with respect to the QOS targets.

In step S450, the UE provides an indication of wake-up of second set of TRPs (e.g., micro TRPs) to the network in case no pre-coding matrices meets the QoS targets.

It will be appreciated that the second method can enable the network to save energy by putting the micro (opportunistically ON) TRPs to lower energy state or completely turned off while macro TRPs are used for coherent transmission. The micro TRPs can remain this way until a UE cannot meet the QoS targets and requests wake-up of one or more of them.

FIG. 5 illustrates a third method according to an embodiment of the present principles. Briefly speaking, in at least an embodiment the third method is for UE-assisted TRP wake-up for MTRP transmissions.

Briefly put, for coherent joint transmissions in heterogeneous TRP deployments including macro (always on) TRPs and micro(/femto) (opportunistically on) TRPs, the UE measures the CSI-RS from a set of macro TRPs, determines CJT pre-coding matrix over macro TRPs and, in case the difference of UE measurements over the strongest micro TRP minus the weakest macro TRP in the CJT matrix exceeds a threshold value, requests an indication of micro TRP wake up for CJT.

In step S510, the UE receives network configuration information for coherent joint transmission from a first set of TRPs (e.g., macro TRPs) and a second set of TRPs (e.g., micro TRPs), including of one or more of: one or more RSs (e.g., CSI-RSs) for CSI measurements and feedback associated with each TRP of the first set; one or more RSs (e.g., SSB, slim SSB, MRSS etc.) for measurements and feedback associated with each TRP of the second set; rank restriction (e.g., the overall rank of the reported pre-coding matrix equal to or exceeding a threshold L); reliability restriction (e.g., the CQI associated with the reported pre-coding matrix equal to or exceeding a threshold C); and a number n of joint pre-coding matrices to report where n may be configured as the minimum, maximum or precise number of reported matrices. The UE can use the received network configuration information to configure itself.

In step S520, the UE receives and measures RSs transmitted by the first set of TRPs, as per the configuration.

In step S530, the UE determines a set of (e.g., best according to some criterion) pre-coding matrices for coherent joint transmission to achieve the QoS (rank/reliability etc.), based upon the measurements.

In step S540, the UE validates the determined pre-coding matrices with respect to the QOS targets.

In step S550, in case none of the UE computed pre-coding matrices meets the QoS targets, the UE measures the RSs associated with the second set of TRPs.

In step S560, the UE determines m (e.g., the m best according to some criterion) TRPs from the measurements made on the RSs of the second set of TRPs, e.g., corresponding to the largest measured RSRP values on the RSs associated with the second set of TRPs.

In step S570, the UE provides an indication of its determined m TRPs from the second set of TRPs. The indication can be sent to the network.

It will be appreciated that the third method can enable the network to save energy by putting the micro (opportunistically ON) TRPs to lower energy state or completely turned off while macro TRPs are used for coherent transmission and, if a UE cannot meet the QoS targets, the UE requests targeted wake up of sleeping TRPs by providing the indication of suitable TRPs.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency trade-offs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶, 6 or means-plus-function claim format, and any claim without the terms “means for” is not so intended.

1. A method at a wireless transmit/receive unit, WTRU, the method comprising:
measuring reference signals, RSs, received from transmit/receive points, TRPs, in a first set of TRPs to obtain first measurements;
measuring RSs received from TRPs in a second set of TRPs to obtain second measurements;
evaluating a wake-up condition based upon a measured RS in a subset of the first measurements and a measured RS in the second measurements; and
on condition that the wake-up condition is satisfied, transmitting a wake-up signal, the wake-up signal requesting the TRP having transmitted a strongest measured RS in the second measurements to wake up.

2. The method of claim 1, wherein:
the wake-up condition is evaluated based upon the measurement corresponding to a weakest measured RS in the subset of the first measurements and the measurement corresponding to a strongest measured RS in the second measurements.

3. The method of claim 2, wherein:
the wake-up condition is evaluated based on a difference between the measurement corresponding to the strongest measured RS in the second measurements and the measurement corresponding to the weakest measured RS in the subset of the first measurements.

4. The method of claim 3, wherein:
the wake-up condition is satisfied in case the difference is greater than a given value.

5. The method of claim 1, wherein:
a configured periodicity of RS transmission of the first set of TRPs is higher than a configured periodicity of RS transmission of the second set of TRPs.

6. The method of claim 1, comprising:
verifying that the TRP having transmitted the strongest measured RS has woken up.

7. The method of claim 1, comprising:
measuring RSs received from TRPs, including the TRP having transmitted the strongest measured RS to obtain third measurements; and
reporting channel state information based on the third measurements.

8. The method of claim 1, comprising:
determining, based on the first measurements and using at least one evaluation criterion, a set of pre-coding matrices for coherent joint transmission to achieve a Quality of Service, QoS, and selecting a pre-coding matrix from the set of pre-coding matrices;
wherein the selected pre-coding matrix is for a subset of the first set of TRPs; and
wherein the subset of the first measurements correspond to measurements from the subset of the first set of TRPs.

9. A wireless transmit/receive unit, WTRU, comprising at least one processor configured to:
measure reference signals, RSs, received from transmit/receive points, TRPs, in a first set of TRPs to obtain first measurements;
measure RSs received from TRPs in a second set of TRPs to obtain second measurements;
evaluate a wake-up condition based upon a measured RS in a subset of the first measurements and a measured RS in the second measurements; and
on condition that the wake-up condition is satisfied, transmit a wake-up signal, the wake-up signal requesting the TRP having transmitted a strongest measured RS in the second measurements to wake up.

10. The WTRU of claim 9, wherein the at least one processor is configured to:
evaluate the wake-up condition based upon the measurement corresponding to a weakest measured RS in the subset of the first measurements and the measurement corresponding to a strongest measured RS in the second measurements.

11. The WTRU of claim 10, wherein the at least one processor is configured to:
evaluate the wake-up condition based on a difference between the measurement corresponding to the strongest measured RS in the second measurements and the measurement corresponding to the weakest measured RS in the subset of the first measurements.

12. The WTRU of claim 11, wherein:
the wake-up condition is satisfied in case the difference is greater than a given value.

13. The WTRU of claim 9, wherein:
a configured periodicity of RS transmission of the first set of TRPs is higher than a configured periodicity of RS transmission of the second set of TRPs.

14. The WTRU of any one of claims 9-13, wherein the at least one processor is configured to:
verify that the TRP having transmitted the strongest measured RS has woken up.

15. The WTRU of claim 9, wherein the at least one processor is configured to:
measure RSs received from TRPs, including the TRP having transmitted the strongest measured RS to obtain third measurements; and
report channel state information based on the third measurements.

16. The WTRU of claim 9, wherein the at least one processor is configured to:
determine, based on the first measurements and using at least one evaluation criterion, a set of pre-coding matrices for coherent joint transmission to achieve a Quality of Service, QoS, and selecting a pre-coding matrix from the set of pre-coding matrices;
wherein the selected pre-coding matrix is for a subset of the first set of TRPs; and
wherein the subset of the first measurements correspond to measurements from the subset of the first set of TRPs.

17. A method at a wireless transmit/receive unit, WTRU, the method comprising:
measuring, in a network, reference signals, RSs, received from transmit/receive points, TRPs, in a first set of TRPs to obtain first measurements;
determining, based on the first measurements and using at least one evaluation criterion, one or more pre-coding matrices for coherent joint transmission to achieve a Quality of Service, QoS;
validating the determined one or more pre-coding matrices with respect to the QoS targets;
in case no pre-coding matrix is validated, measuring RSs received from TRPs in a second set of TRPs to obtain second measurements;
determining, using the second measurements and at least one determination criterion, TRPs of the second set of TRPs; and
providing to the network an indication of the determined TRPs.

18. The method of claim 17, wherein:
the determined TRPs correspond to highest measured signal strengths among the second measurements.

19-22. (canceled)
